(19) United States
(12) Patent Application Publication
(10) Pub. No.: US 2016/0378583 A1
(43) Pub. Date: Dec. 29, 2016

(54) MANAGEMENT COMPUTER AND METHOD FOR EVALUATING PERFORMANCE THRESHOLD VALUE

(71) Applicant: Hitachi, Ltd., Tokyo (JP)

(72) Inventors: Kaori NAKANO, Tokyo (JP); Mineyoshi MASUDA, Tokyo (JP); Yasuyuki MIMATSU, Tokyo (JP); Yutaka KUDOU, Tokyo (JP)

(21) Appl. No.: 15/121,425

(22) PCT Filed: Jul. 28, 2014
(86) PCT No.: PCT/JP2014/069808

§ 371 Date: Aug. 25, 2016

(51) Int. Cl. G06F 11/07; G06F 11/34; G06F 11/30

(52) U.S. Cl. CPC G06F 11/079; G06F 11/0709; G06F 11/0751; G06F 11/3006; G06F 11/3409; G06F 11/3495

(57) ABSTRACT

A management computer has a processor configured to: select a service performance name pairing with a received first apparatus performance name; select a performance value of the received first apparatus performance name and a performance value of the selected service performance name; select a threshold of the first apparatus performance name and a threshold of the selected service performance name; determine whether the performance value of the first apparatus performance name exceeds the threshold of the first apparatus performance name within a predetermined period; determine whether the performance value of the service performance name exceeds the threshold of the service performance name within the predetermined period; and when a determination result of the performance value of the first apparatus performance name and a determination result of the performance value of the service performance name are the same result simultaneously, increase evaluation of the threshold of the first apparatus name.

### BACKGROUND

The technique disclosed the Description relates to a management computer configured to manage a computer system.

In management of an information technology (IT) system, it is monitored whether or not a service provided by the IT system and apparatus and parts thereof (hereinafter sometimes referred to as “infrastructure”) that form the IT system are operating normally. As one of monitored items as to whether or not the service is being provided normally and whether or not the infrastructure is operating normally, there is performance monitoring. In the performance monitoring, monitoring software is used to collect performance information (including a value of a load on a monitoring target) and to present the performance information to an administrator. Further, the monitoring software includes observing the load and the like of the monitoring target and determining whether statuses of the service and the infrastructure are normal or abnormal based on whether or not a threshold set in advance is exceeded. When it is determined that the status is abnormal, the administrator of the IT system (hereinafter sometimes referred to simply as “administrator”) is notified of an alert indicating that the status has become abnormal.

It is difficult for the administrator to set the threshold for determining whether performance being monitored is normal or abnormal, which requires some know-how. For example, the threshold for the performance monitoring of the service can be derived directly from a service level agreement (SLA) or a service level objective (SLO). However, the threshold for monitoring performance of the infrastructure needs to be set in association with the threshold of the service in consideration of correlation between performance of the service and the performance of the infrastructure.

Further, in recent years, the apparatus and the parts that form the IT system are increasing in scale and diversifying as well, and the number and kinds of monitoring targets are increasing. Therefore, it requires time and labor to set the threshold and verify whether or not the set threshold is appropriate.

To cope with those problems, in JP 2011-198262 A, there is described a technology for setting a threshold for the performance monitoring in advance in an apparatus to be managed through use of monitoring software and detecting a case where an acquired performance value exceeds the threshold as a performance failure event.

### SUMMARY

As described in JP 2011-198262 A, a technology for automatically setting a threshold includes calculating an “appropriate threshold” through use of values of performance information on the service and the infrastructure that have been observed. However, in general monitoring software used by the administrator of the IT system, loads on the monitoring target are collected with a regular cycle period. Therefore, when there occurs an abrupt load on the monitoring target, the value of the abrupt load may not be able to be observed or may be leveled with another value depending on a timing to collect the performance information. Further, when there is a limit to the collection period for the observed value of the performance information used for calculating the threshold by the automatic threshold setting technology, a method of operating the monitoring target and the service provided by the monitoring target exhibit loads deviating depending on a time slot, and hence when the calculated threshold is used for another time slot, the “appropriate threshold” may not be able to be calculated. For those reasons, with the automatic threshold setting technology, the “appropriate threshold” may not be able to be derived at once immediately after installation thereof.

In a case where the “appropriate threshold” is not set, in the performance monitoring, a necessary alert may fail to be notified even when a performance failure has occurred, or an unnecessary alert may be notified even when there is no problem in the performance. This raises a problem in that the administrator cannot appropriately analyze or handle the performance failure. Therefore, the administrator needs to know whether or not the set threshold is sufficiently appropriate. When the threshold is not sufficiently appropriate, there is a need to change how to analyze the notified alert or how to handle the performance failure.

The representative one of inventions disclosed in this application is outlined as follows. There is provided a management computer configured to monitor a system including an apparatus, the management computer comprising a storage unit, a processor configured to refer to the storage unit, and an interface for communications to/from the apparatus. The storage unit is configured to hold performance information including a performance value of the apparatus and a performance value of a service provided by the system, setting threshold information including a threshold which is used for determining whether or not each of the performance values is abnormal, and service infrastructure performance relationship information including a pair of a service performance name and an apparatus performance name that exhibit correlation in change of performance. The processor is configured to: select, in the case of receiving a first apparatus performance name for identifying the performance of the apparatus, the service performance name that forms a pair with the received first apparatus performance name from the service infrastructure performance relationship information; select the performance value of the received first apparatus performance name and the performance value of the selected service performance name from the performance information; select the threshold of the first apparatus performance name and the threshold of the selected service performance name from the setting threshold information; determine whether or not the performance of the first apparatus performance name exceeds the threshold of the first apparatus performance name within a predetermined period; determine whether or not the performance value of the service performance name exceeds the threshold of the service performance name within the predetermined period; evaluate the threshold of the first apparatus performance name so as to increase evaluation of the threshold when a determination result of the performance value of the first apparatus performance name and a determination result of the performance value of the service performance name are the same result simultaneously; and output an evaluation result of the threshold.

According to the representative embodiment of this invention, it is possible to present whether or not the set threshold needs to be reviewed. Objects, configurations, and effects other than those described above become apparent by the following descriptions of embodiments of this invention.

### BRIEF DESCRIPTION OF THE DRAWINGS

FIG. 1 is a diagram for illustrating an outline of embodiments of this invention.

FIG. 2A is a diagram for illustrating an example of configuration of an IT system according to a first embodiment.

FIG. 2B is a diagram for illustrating an example of configuration of a management computer according to the first embodiment.

FIG. 3 is a diagram for illustrating an example of a configuration of a performance information table according to the first embodiment.

FIG. 4 is a diagram for illustrating an example of a configuration of a setting threshold table according to the first embodiment.

FIG. 5 is a diagram for illustrating an example of a configuration of a service and infrastructure metric relationship table according to the first embodiment.

FIG. 6 is a diagram for illustrating an example of a configuration of a service and I/O metric relationship table according to the first embodiment.

FIG. 7 is a diagram for illustrating an example of a configuration of a threshold evaluation table according to the first embodiment.

FIG. 8 is a flowchart of an example of threshold evaluation processing according to the first embodiment.

FIG. 9A and FIG. 9B are flowcharts for illustrating an example of a linkage determination processing according to the first embodiment.

FIG. 10 is a diagram for illustrating an example of a linkage determination table according to the first embodiment.

FIG. 11A is a diagram for illustrating an example of a threshold evaluation result screen according to the first embodiment.

FIG. 11B is a diagram for illustrating an example of an alert list screen according to the first embodiment.

FIG. 12 is a diagram for illustrating an example of a configuration of a service and infrastructure metric relationship table according to a second embodiment.

FIG. 13A, FIG. 13B and FIG. 13C are flowcharts of an example of a linkage determination processing according to the second embodiment.

FIG. 14 is a diagram for illustrating an example of a linkage determination table according to the second embodiment.

FIG. 15 is a diagram for illustrating an example of a configuration of a setting threshold table according to a third embodiment.

FIG. 16 is a flowchart of an example of threshold evaluation processing according to the third embodiment.

FIG. 17 is a flowchart of an example of a configuration of an alert table according to a fourth embodiment.

FIG. 18 is a flowchart of an example of a configuration of a rule stored in a rule repository according to the fourth embodiment.

FIG. 19 is a flowchart of an example of a root cause analysis processing according to the fourth embodiment.

FIG. 20 is a diagram for illustrating an example of a root cause analysis result screen according to the fourth embodiment.

FIG. 21A is a diagram for illustrating an example of a root cause analysis result screen according to a fifth embodiment.

FIG. 21B is a diagram for illustrating an example of a reanalysis screen according to the fifth embodiment.

FIG. 22 is a flowchart of an example of a root cause analysis processing according to the fifth embodiment.

FIG. 23A, FIG. 23B and FIG. 23C are flowcharts of a recalculation processing according to the fifth embodiment.

FIG. 24 is a diagram for illustrating an example of an exceptional metric table according to the second embodiment.

### DETAILED DESCRIPTION OF THE PREFERRED EMBODIMENTS

A description of this invention is made below in detail with reference to the accompanying drawings including parts of the disclosure. Those drawings are illustrations of exemplary embodiments that allow this invention to be carried out, and do not intend to limit this invention. In those drawings, like components are denoted by like reference symbols across a plurality of drawings. Further, the detailed description provides different kinds of exemplary embodiments, but it should be noted that, as described below and as illustrated in the drawings, this invention is not limited to the description of the specification or the embodiments described with reference to the drawings, and can be extended to other embodiments which are known or will be known to a person skilled in the art.

The wording “this embodiment” referred to in this specification means that specific features, structures, or characteristics described in association with this embodiment are included in at least one embodiment of this invention, and words and phrases relating thereto do not always indicate the same embodiment even when appearing in each section of this specification.

In the following detailed description, a large number of specific detailed items are disclosed so as to allow this invention to be fully understood. However, as is clear to a person skilled in the art, not all those specific detailed items are required for carrying out this invention. In order to avoid unnecessarily complicating this invention in another situation, known structures, materials, circuits, processing, and interfaces may not be described in detail and/or may be illustrated in the form of a block diagram.

A certain part of the following detailed description is expressed as an algorithmic representation and a symbolic representation of an operation inside the computer. The algorithmic description and the symbolic representation are means used by a person skilled in the art, who is well acquainted with a data processing technology, in order to most effectively transmit the nature of his or her own invention to another person skilled in the art. The algorithm represents a defined series of steps for achieving a desired final state or result. In this invention, the steps to be executed require a physical operation of a tangible amount for achieving a tangible result.

Normally, but not mandatorily, those amounts are represented in such a form of an electric or magnetic signal as to be able to be saved, transferred, combined, compared, and subjected to other such operations. It is known that it is often convenient to refer to those signals as “bits”, “values”, “elements”, “symbols”, “characters”, “items”, “numbers”, “instructions”, and the like because those signals can be used fundamentally in common. However, it should be noted that all thereof and items similar thereto need to be associated with appropriate physical amounts, and are merely convenient labels assigned to those physical amounts.

Unless otherwise specified, as is clear from the following description, through the description of this specification, the description using the terms “process”, “calculate”, “derive”, “determine”, “display”, and the like may include an operation and processing of another information processing apparatus configured to operate data expressed as a physical (electronic) amount inside a computer system or inside a register and a memory of the computer system, and to convert such data into another data expressed in the same manner as a physical amount inside the memory or the register of the computer system or inside another information storage apparatus, another transmission apparatus, or another display apparatus.

This invention also relates to an apparatus configured to execute an operation described in this specification. The above-mentioned apparatus may be constructed specially for a necessary purpose, or may include one or more general-purpose computers that are selectively booted or reconfigured by one or more computer programs. Such computer programs can be saved to, for example, computer-readable storage media, e.g., an optical disc, a magnetic disk, a read-only memory, a random access memory, a solid-state drive, or other kinds of drives, or other arbitrary media suitable for saving electronic information, but this invention is not limited thereto.

The algorithm and the display that are described in this specification do not intrinsically relate to any specific computers or other apparatus. Different kinds of general-purpose systems may be used along with a program and a module according to the teaching of this specification, but it may be found more convenient to construct a more specialized apparatus for executing a desired method and desired steps. Structures of those different kinds of systems become apparent from the description disclosed below. Further, the description of this invention does not include any specific programming languages as a precondition. As described below, it should be understood that different kinds of programming languages may be used for executing the teaching of this invention. Instructions in the programming language can be executed by one or more processing units, for example, a central processing unit (CPU), a processor, or a controller.

In the following description, information used in this invention are represented by the expressions “aaa table”, “aaa list”, “aaa repository'8 , “aaa table”, and the like, but those pieces of information may be expressed by a form other than the table, the list, the repository, and other such data structures. Therefore, the “aaa table”, the “aaa list”, the “aaa repository”, the “aaa table”, and the like are sometimes referred to as “aaa information” in order to indicate that this invention does not depend on the kind of data structure.

In addition, the expressions “identification information”, “identifier”, “name”, and “ID” are used to describe the content of each piece of information, and can be replaced by one another.

In the following description, a “program” and “processing” are each sometimes used as the subject of a sentence. The program is executed by a processor, to thereby conduct predetermined processing through use of a memory and a communication port (communication control device), and hence the processor may be used as the subject of a sentence in the description. Further, processing disclosed by using the program as the subject of a sentence may be set as processing to be conducted by a computer, e.g., a management server, or an information processing apparatus. Further, a part or an entirety of the program may be achieved by dedicated hardware.

Further, different kinds of programs may be installed on each computer through a program distributing server or a computer-readable storage medium.

It should be noted that a management computer includes an input/output device. As an example of the input/output device, a display, a keyboard, and a pointer device are conceivable, but other devices may be employed. As a substitute for the input/output device, a serial interface or an Ethernet interface may be employed as the input/output device. In that case, with the above-mentioned interface being coupled to a computer for display including the display, the keyboard, or the pointer device, information for display is transmitted to the computer for display, and information for input is received from the computer for display, to thereby conduct display on the computer for display and receive input. In this manner, the input and the display through the input/output device may be substituted.

In the following description, a set of one or more computers configured to manage an IT system (information processing system) and to display the information for display is sometimes referred to as “management system”. When the management computer is configured to display the information for display, the management computer may be set as the management system. A combination of the management computer and the computer for display may be set as the management system. Further, a plurality of computers may achieve processing equivalent to the processing of the management computer in order to increase the speed and reliability of management processing. In this case, the plurality of computers (including the computer for display when the display is conducted by the computer for display) may be set as the management system. The “displaying of the information for display” conducted by the management computer may represent that the information for display is displayed on the display device included in the management computer, or may represent that the management computer (for example, server) transmits the information for display to a remote computer for display (for example, client).

In the following description, when elements of the same kind are distinguished from each other, reference symbols of the elements are used, and when the elements of the same kind are not distinguished from each other, a parental reference symbol common to the reference symbols of the elements is sometimes used. For example, the server is described as “server 202” when the servers are not particularly distinguished from each other, and the servers are sometimes described as “server 202a” and “202b” when the individual servers are distinguished from each other.

### Outline of Embodiments

As described below in detail, according to the embodiment of the invention, there is provided an apparatus configured to evaluate a set threshold in performance monitoring of apparatus and parts thereof that form an IT system, and to display an evaluation result including an evaluation value, and there are also provided a method therefor and a computer program therefor. In other words, in the embodiment of this invention, effectiveness of the threshold set in monitoring software is digitized and evaluated, and the evaluation result is presented to the administrator.

The evaluation of the threshold is conducted based on the premises that there is correlation between performance of a monitoring target of the type referred to as “service” and performance of a monitoring target of the type referred to as “infrastructure” and that a fixed value that requires no adjustment is defined as the threshold of performance information on the service based on an SLA, an SLO, or the like. Therefore, the evaluation of the threshold is carried out on the threshold of each performance metric of the monitoring target classified into the infrastructure. Further, the evaluation value is calculated based on a linkage rate between a timing at which the performance metric of the infrastructure exceeds the threshold and a timing at which the performance metric of the service relating thereto exceeds the threshold.

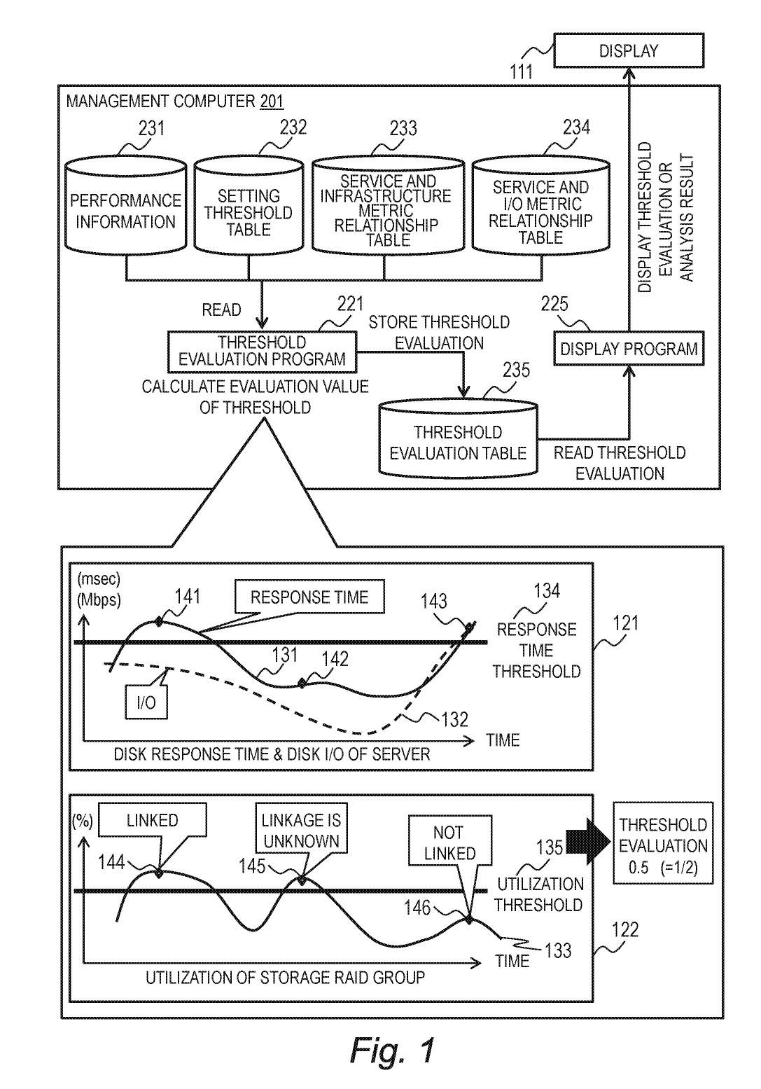

FIG. 1 is a diagram for illustrating an outline of the embodiment of this invention, in particular, an illustration of a configuration of the IT system.

A management computer 201 of the IT system according to this embodiment is a computer configured to manage a plurality of management target apparatus. The types of the management target apparatus include, for example, at least one of a computer (for example, server), a network apparatus (for example, Internet protocol (IP) switch, router, or fibre channel (FC) switch), or a storage apparatus (for example, network attached storage (NAS)). Logical or physical elements, e.g., a device, included in the management target apparatus include, for example, at least one of a port, a processor, a storage resource, a physical storage device, a program, a virtual machine, a logical volume (logical storage device), or a redundant arrays of inexpensive (independent) disks (RAID) group.

The management computer 201 includes a performance information table 231, a setting threshold table 232, a service and infrastructure metric relationship table 233, and a service and I/O metric relationship table 234. The performance information table 231 is a table for storing the performance information (e.g., value of a load) collected from the management target apparatus. The setting threshold table 232 is a table for storing a threshold of the collected performance information on each apparatus. The service and infrastructure metric relationship table 233 is a table for storing a combination of the performance metric of the service and the metric of the performance information on the infrastructure having correlation with performance of the service. The service and I/O metric relationship table 234 is a table for storing a combination of the performance metric of the service and the metric of the performance information relating to input/output (I/O) that exerts an influence on the performance of the service.

When the performance metric having a threshold to be evaluated is specified by the administrator or another program, the management computer 201 executes a threshold evaluation program 221 for calculating the evaluation value of the threshold. The threshold evaluation program 221 reads data of the performance information table 231, the setting threshold table 232, the service and infrastructure metric relationship table 233, and the service and I/O metric relationship table 234, and calculates the evaluation value of the threshold based on the read data. The evaluation value is calculated based on the linkage rate between the timing at which the performance metric of the infrastructure exceeds the threshold and the timing at which the performance metric of the service relating thereto exceeds the threshold.

FIG. 1 is a diagram for illustrating an example of processing for evaluating, by the threshold evaluation program 221, the threshold of a utilization of a storage RAID group with a disk response time of the server being set as the performance metric of the “service” and the utilization of the storage RAID group being set as the performance metric of the “infrastructure”. In the example illustrated in FIG. 1, the service and infrastructure metric relationship table 233 is assumed to define that there is correlation between the disk response time of the server and the utilization of the storage RAID group. The reason that it is defined that there is correlation between the disk response time of the server and the utilization of the storage RAID group is based on the knowledge that the disk response time exhibits a delay due to a high utilization of the RAID group.

In the example illustrated in FIG. 1, “disk I/O of the server” is defined in the service and I/O metric relationship table 234 as the performance metric of the I/O that exerts an influence on the disk response time of the server. A graph 121 and a graph 122 are time series graphs of performance values of the respective performance metrics, which are stored in the performance information table 231. In comparison between the disk response time and the utilization at a given time, for example, data points 141 and 144, a threshold 134 of the disk response time is exceeded at the data point 141, and a utilization threshold 135 is exceeded at the data point 144. From this result, at the given time, the timings at which the disk response time of the server and the utilization of the storage RAID group exceed the thresholds are linked with each other, and hence the utilization threshold 135 is determined to be normal.

Meanwhile, in comparison between data points 143 and 146, the disk response time exceeds the threshold, but the utilization does not exceed the threshold, and hence the utilization threshold 135 is determined to be abnormal at this time. At data points 142 and 145, the disk response time does not exceed the threshold, and the utilization exceeds the threshold. However, the disk I/O of the server is low, and hence it is determined that presence or absence of the linkage is unknown. This is because the disk response time is zero when there is no disk access occurring in the first place even under a state in which the storage RAID group deteriorates in performance, and hence the case where the disk I/O is low does not provide data effective for determining the presence or absence of the linkage.

In this manner, the threshold evaluation program 221 calculates the evaluation value of the threshold based on whether or not the performance metrics having correlation exceed the thresholds in linkage with each other. For example, in the case of the example illustrated in FIG. 1, there is one data point determined to exhibit the linkage, and there is one data point determined not to exhibit the linkage. Therefore, the number of times of the linkage is one out of the two data points, and hence the evaluation value is set to 1/2=0.5.

The threshold evaluation program 221 stores the evaluation value of the threshold calculated in the above-mentioned manner in a threshold evaluation table 235. Then, a display program 225 reads the evaluation value of the threshold from the threshold evaluation table 235 in response to a request issued by the administrator or another program, and displays the evaluation value on a display 111.

According to this embodiment, it is possible to digitize evaluation of the threshold set for each performance metric in the performance monitoring. As a result, it is possible to present whether or not to review threshold setting based on the evaluation of the threshold. Further, the evaluation value of the threshold is displayed together when the administrator is notified of an alert indicating that the set threshold is exceeded, to thereby be able to present whether or not the generated alert is reliable or whether or not the administrator needs to inspect the performance information in detail through direct examination. This allows the administrator to determine whether or not to review the set threshold. Further, it is possible to determine a method of handling and analyzing the generated alert.

### First Embodiment

Now, a first embodiment of this invention is described in detail.

<Configurations of IT System and Management Computer>

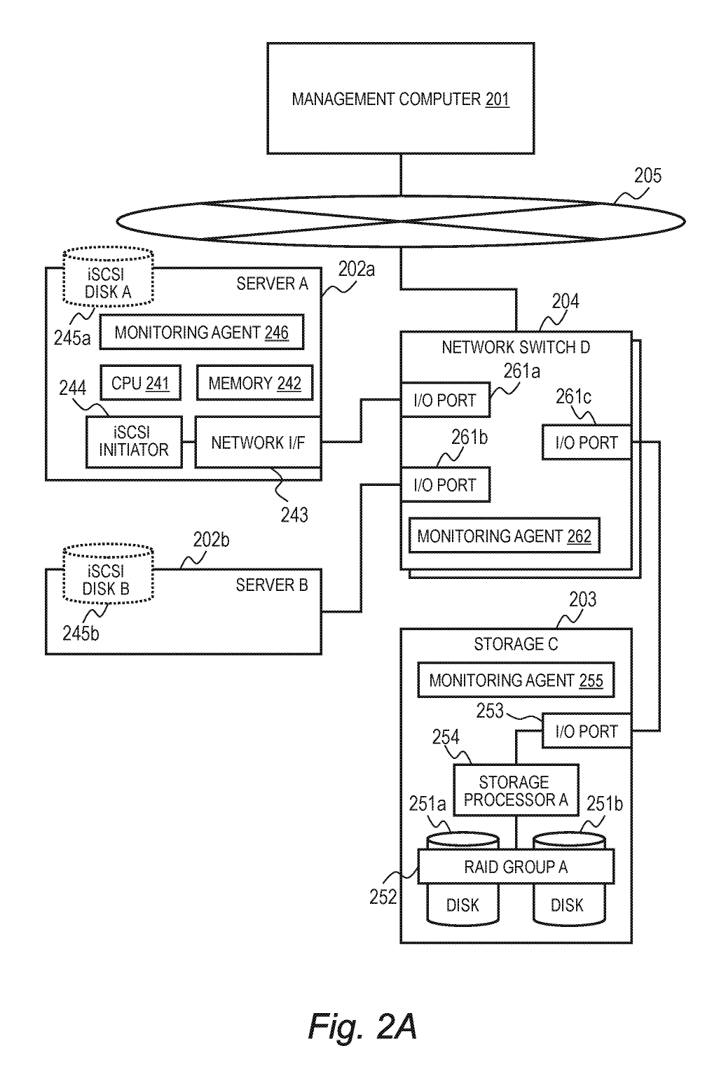

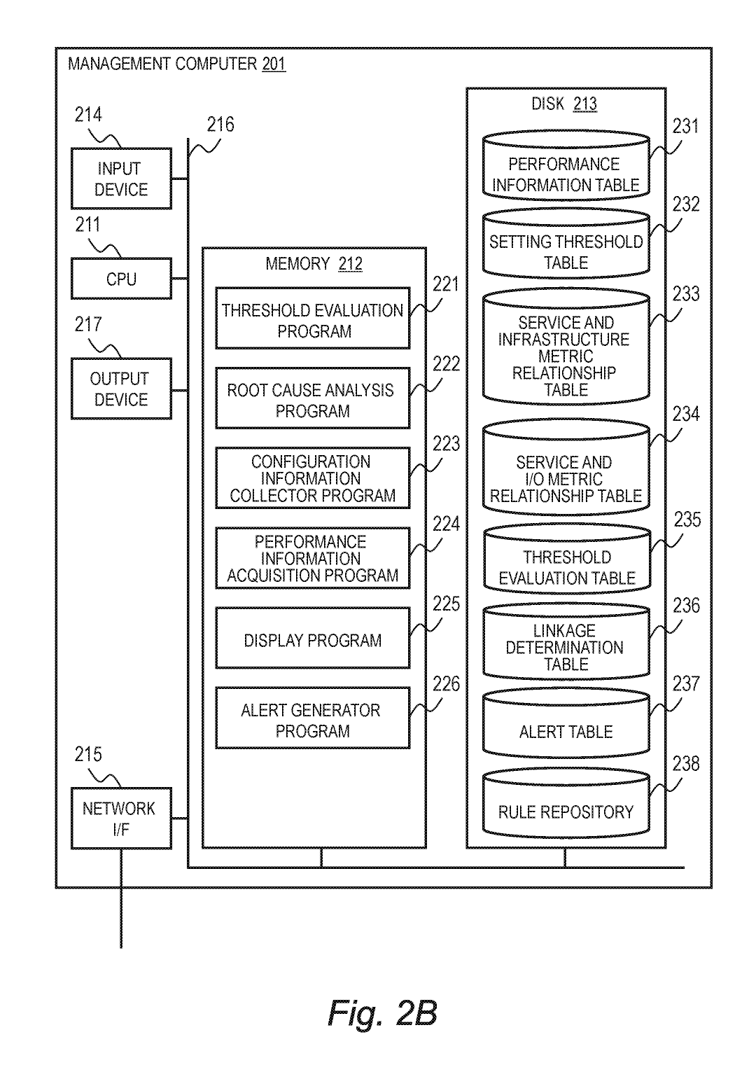

FIG. 2A is a diagram for illustrating an example of hardware and, logical configurations of the IT system according to the first embodiment, and FIG. 2B is a diagram for illustrating an example of hardware and logical configurations of the management computer 201 according to the first embodiment.

The IT system according to the first embodiment includes one or more servers (or other computers) 202a and 202b, one or more storage apparatus 203, and one or more network switches (or other network apparatus, e.g., IP switches) 204. The servers 202a and 202b, the storage apparatus 203, and the network switches 204 are communicably coupled to one another through a network 205 (network switch 204 in the example illustrated in FIG. 2A and FIG. 2B), e.g., a local area network (LAN).

The management computer 201 may be a general-purpose computer including a CPU 211, a memory 212, a disk 213, an input device 214, an output device 217, and a network interface device (network I/F) 215 which are coupled to one another through a system bus 216. The disk 213 is, for example, a hard disk drive (HDD), but another nonvolatile storage device, e.g., a solid state drive (SSD) may be employed instead.

The management computer 201 includes, as logical modules, for example, the threshold evaluation program 221, a root cause analysis program 222, a configuration information collector program 223, a performance information acquisition program 224, the display program 225, and an alert generator program 226. Further, the management computer 201 stores, as stored data, for example, the performance information table 231, the setting threshold table 232, the service and infrastructure metric relationship table 233, the service and I/O metric relationship table 234, the threshold evaluation table 235, a linkage determination table 236, an alert table 237, and a rule repository 238.

The performance information table 231 is a database for saving the performance information on a management target component, which is collected from the management target apparatus by the performance information acquisition program 224. The performance information table 231 may be held by each management target apparatus instead of being held by the management computer 201. In this case, the management computer 201 may access each management target apparatus through the network 205 in order to refer to the performance information, and may acquire the performance information.

The threshold evaluation program 221, the root cause analysis program 222, the configuration information collector program 223, the performance information acquisition program 224, the display program 225, and the alert generator program 226 are stored in the memory 212 and executed by the CPU 211. The data of the performance information table 231, the setting threshold table 232, the service and infrastructure metric relationship table 233, the service and I/O metric relationship table 234, the threshold evaluation table 235, the linkage determination table 236, the alert table 237, the rule repository 238, and the like is stored on the disk 213. Of those, at least one program or at least one piece of data may be stored in another appropriate storage area that can be referred to by the CPU 211.

The network I/F 215 acquires information relating to a component, e.g., configuration information and performance information, from the management target apparatus, e.g., the server 202, the storage apparatus 203, or the network switch 204, through the network 205. The output device 217 is a device configured to output (typically, display) information from the display program 225. The input device 214 is a device configured to input a user's instruction. For example, a keyboard or a pointer device can be used as the input device 214, and a display or a printer can be used as the output device 217, but another device may be used.

The root cause analysis program 222, the alert generator program 226, the alert table 237, and the rule repository 238, which are illustrated in FIG. 2B, are used in a fourth embodiment of this invention, and are not mandatory in other embodiments. Therefore, details thereof are described in the fourth embodiment.

Each of the servers 202a and 202b may be a management target apparatus configured to execute a program, e.g., an application. The server 202a may be a general-purpose computer including a memory 242, a network I/F 243, and a CPU 241 coupled thereto. Further, a physical server is taken as an example in this embodiment, but the server 202a may be a virtual machine. The server 202a may also include not only the memory 242 but also a nonvolatile storage device, e.g., an HDD.

The server 202a may include a monitoring agent (program) 246 for monitoring the configuration and the performance of the server 202a and transmitting at least one of the configuration information or the performance information on the server 202a through the network 205 in response to a request issued by the management computer 201. The monitoring agent 246 may be executed by the CPU 241. The server 202a may include an Internet small computer system interface (iSCSI) initiator 244. For example, the server 202a can use an iSCSI disk 245a virtually as a local HDD. The iSCSI disk 245a is achieved by the iSCSI initiator 244 and a storage capacity of the storage apparatus 203. In place of or in addition to the iSCSI, another communication and storage protocol may be used. The configuration of the server 202a has been described above, but the server 202b may have the same configuration as that of the server 202a.

Each storage apparatus 203 may be a management target apparatus for providing a storage capacity (logical volume) for an application operating on the server 202 (or for another purpose). The storage apparatus 203 includes an I/O port 253, a disk 251, and a storage controller (for example, CPU) 254 coupled thereto. There may exist a plurality of I/O ports 253. The disk 251 may be one HDD, or may be a RAID group 252 formed of a plurality of HDDs. Further, the nonvolatile storage device being the disk 251 may be another storage device, e.g., an SSD. In this embodiment, the storage apparatus 203 may be configured to provide the servers 202a and 202b with iSCSI logical volumes as the storage capacity. Therefore, the two servers 202a and 202b may be coupled to the storage apparatus 203 through the network switch 204, and the storage apparatus 203 may provide the respective servers 202a and 202b with the iSCSI logical volumes. Further, the storage apparatus 203 may include a monitoring agent (program) 255 for monitoring the configuration and the performance of the storage apparatus 203 and transmitting at least one of the configuration information or the performance information on the storage apparatus 203 through the network 205 in response to a request issued by the management computer 201. The monitoring agent 255 may be executed by the storage controller 254. In another case, the monitoring agent 246 of the server 202 may monitor the storage apparatus 203.

The network switch 204 includes ports 261a to 261c each configured to receive the data transmitted from the server 202 or the storage apparatus 203, and to transmit the received data. Further, the network switch 204 may include a monitoring agent (program) 262 for monitoring at least one of the configuration or the performance of the network switch 204 and transmitting at least one of the configuration information or the performance information on the network switch 204 to the management computer 201 through the network 205 in response to a request issued by the management computer 201. The monitoring agent 262 may be executed by a CPU (not shown) within the network switch 204. In another case, the monitoring agent 246 of the server 202 may monitor the network switch 204.

<Performance Information Table>

The performance information table 231 stores the performance information on parts of the management target apparatus and services provided by those apparatus, which is acquired from the monitoring agent and the like by the performance information acquisition program 224.

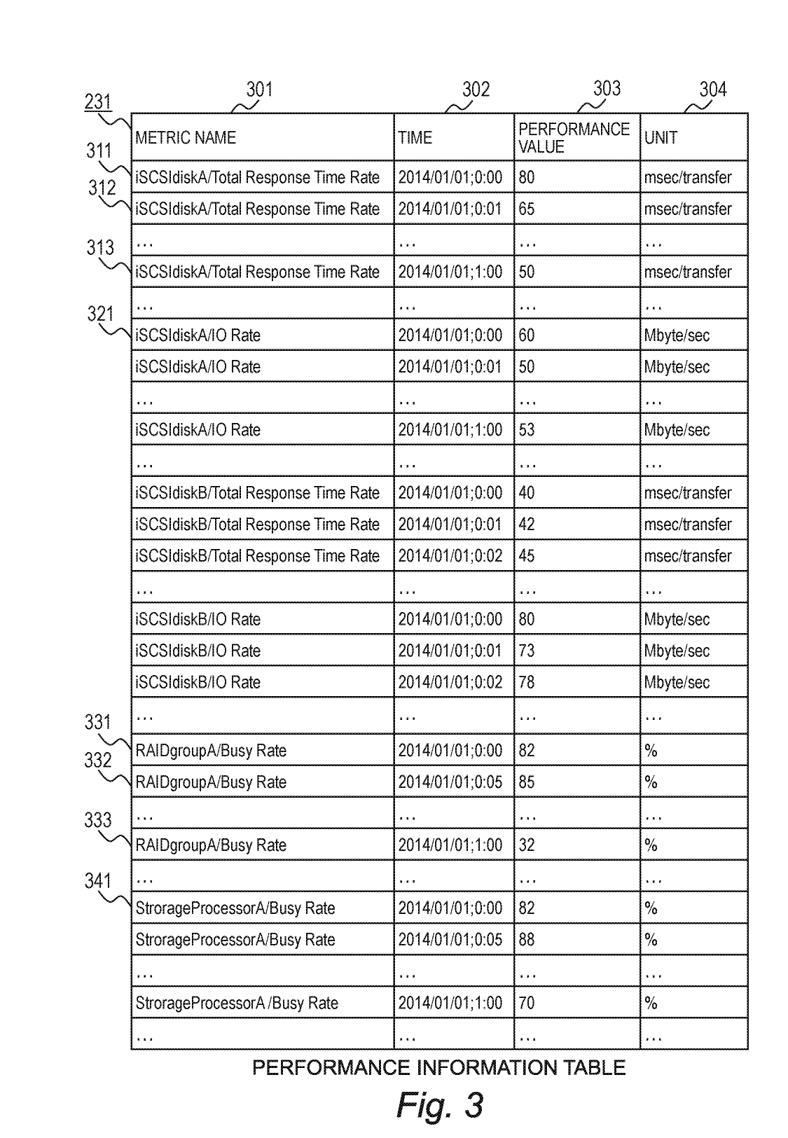

In FIG. 3, an example of a configuration of the performance information table 231 is shown.

The performance information table 231 includes a record for each piece of performance information, and each record includes four fields of a metric name 301, a time 302, a performance value 303, and a unit 304. The metric name 301 stores a value for identifying an observation item (metric) of the performance being monitored. In the example shown in FIG. 3, the metric name is expressed in a data format of “ID for identifying a part of the management target apparatus/type of metric”. The time 302 stores a time at which the performance of the management target was observed. The time is recorded in units of years, months, days, hours, and minutes, but may be recorded in rougher units or finer units. The performance value 303 stores a value observed as the performance of the management target. The unit 304 stores the unit of the observed value.

For example, the record in the first row of the performance information table 231 has the following meaning. The performance of “80 milliseconds/transfer” was observed for the metric name (in this case, response time of an iSCSI disk A of a server A) identified by the identifier “iSCSIdiskA/Total Response Rate” at 0:00, Jan. 1, 2014.

<Setting Threshold Table>

The setting threshold table 232 stores the threshold information used for determining whether or not the observed of the performance information collected by the performance information acquisition program 224 is normal or abnormal.

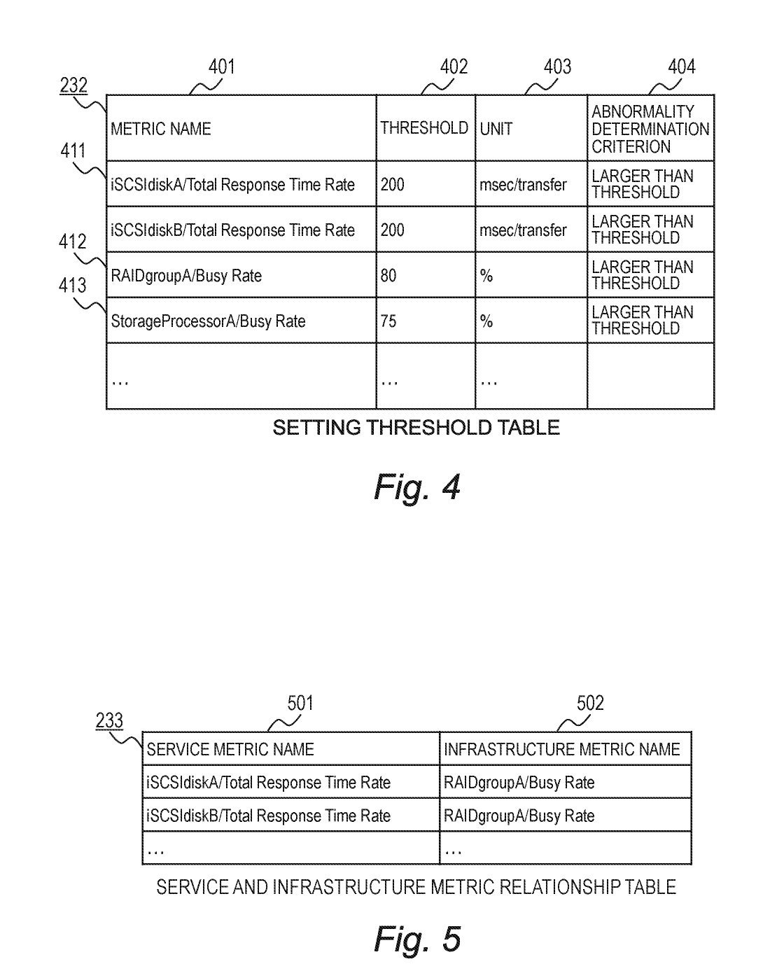

In FIG. 4, an example of a configuration of the setting threshold table 232 is shown.

The setting threshold table 232 includes a record for each performance metric being monitored, and each record includes four fields of a metric name 401, a threshold 402, a unit 403, and an abnormality determination criterion 404. The metric name 401 stores the value for identifying the observation item (metric) of the performance being monitored. The value stored in the metric name 401 is the same as the value stored in the metric name 301 of the performance information table 231. The threshold 402 stores the threshold of the performance of the management target. In this embodiment, the threshold set in the performance monitoring is stored in the threshold 402, but instead of the threshold set in actuality, a value calculated before being set as the threshold by such an automatic threshold setting technology as described in JP2011-198262 A may be stored, or a threshold that is to be set by the administrator may be stored. The unit 403 stores the unit for the threshold. The abnormality determination criterion 404 stores information on a criterion for determining that the observed performance value is abnormal. For example, with “larger than threshold” being stored in the abnormality determination criterion 404, the observed performance value is determined to be abnormal when being larger than the value of the threshold 402. Meanwhile, with “smaller than threshold” being stored, the observed performance value is determined to be abnormal when being smaller than the value of the threshold of 402. At this time, the management computer 201 may activate the display program 225 to display an alert on the display 111.

For example, the record in the first row of the setting threshold table 232 has the following meaning. The performance value observed for the metric name (in this case, response time of the iSCSI disk A of the server A) identified by the identifier “iSCSIdiskA/Total Response Rate” is determined to be abnormal when being larger than “200 milliseconds/transfer”.

<Service and Infrastructure Metric Relationship Table>

The service and infrastructure metric relationship table 233 stores a combination of the metrics having correlation. In this embodiment, the kinds of metric of “service metric” and “infrastructure metric” are defined as the types of performance metrics used in the performance monitoring. The service metric is a performance metric serving as a reference, for which the threshold derived directly based on the SLA or the SLO and requiring no adjustment is defined. The infrastructure metric is a performance metric having correlation with the performance value of the service metric and having the threshold to be adjusted depending on the threshold of the service metric. In this embodiment, “such a relationship as to exert an influence on the performance value of the service metric due to deterioration in the performance of the infrastructure metric” is exemplified as the correlation.

In FIG. 5, an example of a configuration of the service and infrastructure metric relationship table 233 is shown.

The service and infrastructure metric relationship table 233 includes a record for each combination of the service metric and the infrastructure metric, and each record includes two fields of a service metric name 501 and an infrastructure metric name 502. The service metric name 501 stores a value for identifying the performance metric belonging to the type “service metric”. The value stored in the service metric name 501 is the same as the value stored in the metric name 301 of the performance information table 231. The infrastructure metric name 502 stores a value for identifying the performance metric belonging to the type “infrastructure metric”. The value stored in the infrastructure metric name 502 is the same as the value stored in the metric name 301 of the performance information table 231.

For example, the record in the first row has the following meaning. It is indicated that the metric identified by the identifier “iSCSIdiskA/Total Response Rate” and the metric identified by the identifier “RAIDgroupA/Busy Rate” have correlation. In other words, the two metrics have such a relationship that the observed performance values exceed the thresholds at the same timing.

<Service and I/O Metric Relationship Table>

The service and I/O metric relationship table 234 stores a combination of the service metric and an I/O metric that exerts an influence on the performance value of the service metric. The service metric is defined as described with reference to FIG. 5. The I/O metric is a performance metric indicating an input/output amount of data issued when the service metric is observed. There is such a relationship that, when the performance value of the I/O metric is zero, the performance value of the service metric is also zero, and when the performance value of the I/O metric is low, the performance value of the service metric is statistically low as well. For example, with the response time of the disk being set as the service metric, the response time is always zero when the I/O of the disk is zero in the first place. Further, collected values of the response time are leveled within a collection interval, and hence there is a relationship that, when the I/O of the disk is low, the response time is more likely to be low.

In this embodiment, the metric indicating the input/output amount is used as the I/O metric, but a metric indicating any one of an input amount and an output amount may be used.

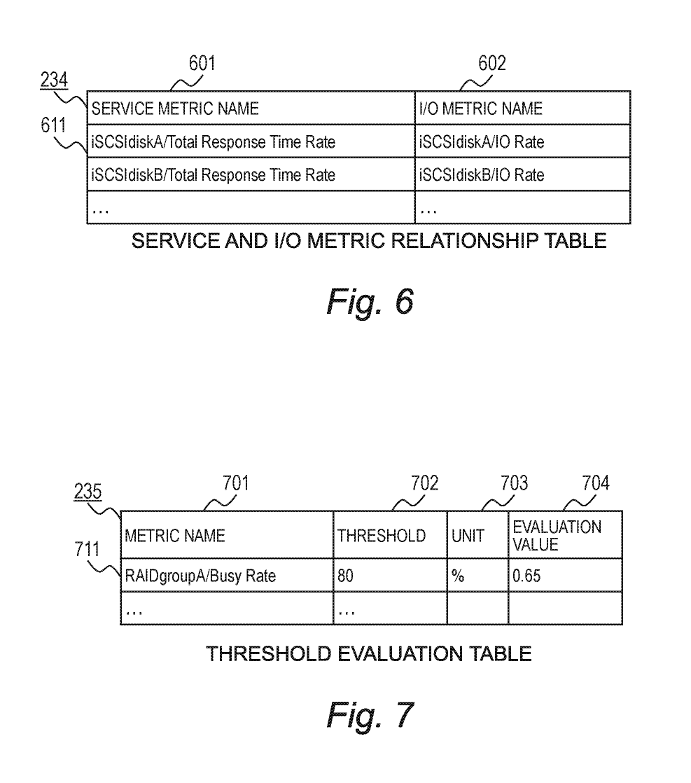

In FIG. 6, an example of a configuration of the service and I/O metric relationship table 234 is shown.

The service and I/O metric relationship table 234 includes a record for each combination of the service metric and the I/O metric, and each record includes two fields of a service metric name 601 and an I/O metric name 602. The service metric name 601 stores a value for identifying the performance metric belonging to the type “service metric”. The value stored in the service metric name 601 is the same as the value stored in the metric name 301 of the performance information table 231. The I/O metric name 602 stores a value for identifying the performance metric indicating an input/output amount of data issued when the service metric is observed. The value stored in the I/O metric name 602 is the same as the value stored in the metric name 301 of the performance information table 231.

For example, the record in the first row has the following meaning. The metric identified by the identifier “iSCSIdiskA/IO Rate” has a relationship with the metric indicating an input/output amount of data issued when the metric identified by the identifier “iSCSIdiskA/Total Response Rate” is observed.

<Threshold Evaluation Table>

The threshold evaluation table 235 stores the evaluation value of the threshold evaluated by the threshold evaluation program 221.

In FIG. 7, an example of a configuration of the threshold evaluation table 235 is shown.

The threshold evaluation table 235 includes a record for each of the evaluated performance metrics, and each record includes four fields of a metric name 701, a threshold 702, a unit 703, and an evaluation value 704. The metric name 701 stores a value for identifying the evaluated performance metric. The value stored in the metric name 701 is the same as the value stored in the metric name 301 of the performance information table 231. The threshold 702 stores the threshold of the performance of the management target. In this embodiment, the threshold set in the performance monitoring is stored in the threshold 702, but instead of the threshold set in actuality, the value calculated before being set as the threshold by such an automatic threshold setting technology as described in JP 2011-198262 A may be stored, or the threshold that is to be set by the administrator may be stored. The unit 703 stores the unit for the threshold. The evaluation value 704 stores a numerical value representing a level of the evaluation of the evaluated performance metric. In this embodiment, the performance metric is evaluated by a value ranging from 0.0 to 1.0, and as the value becomes larger, the effectiveness becomes higher, which indicates that the evaluation is higher.

<Processing of Threshold Evaluation Program>

In this embodiment, processing is executed in order to evaluate the calculated or set threshold. The evaluation of the threshold is conducted based on the premises that there is correlation between the service metric and the infrastructure metric and that a fixed value that requires no adjustment based on the SLA, the SLO, or the like is defined as the threshold of the service metric. Therefore, the threshold of the infrastructure metric is evaluated. The evaluation value is calculated based on the linkage rate between a timing at which the infrastructure metric exceeds the threshold and the timing at which the performance metric of the service relating thereto exceeds the threshold. With this processing, the administrator can determine whether or not the set threshold is an appropriate threshold and whether or not the notified alert is sufficiently effective.

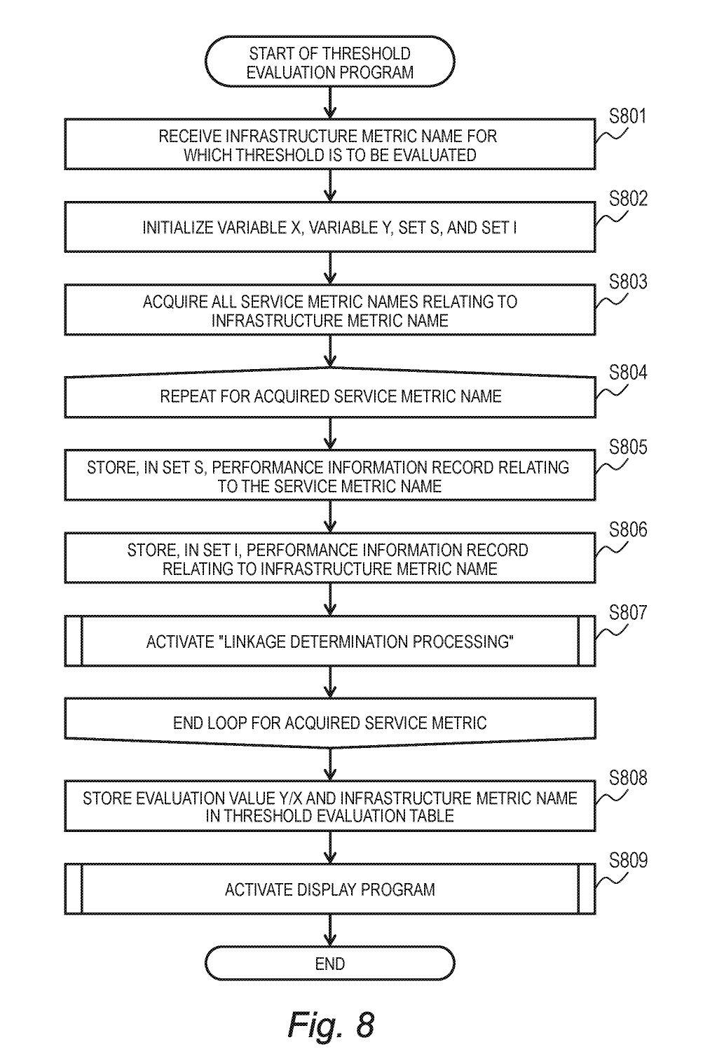

FIG. 8 is a flowchart of an example of threshold evaluation processing executed by the threshold evaluation program 221.

The threshold evaluation program 221 may start this processing when the new threshold is set or when the threshold is calculated by such an automatic threshold setting technology as described in JP 2011-198262 A. Further, this processing may be started at a timing to notify the administrator of an alert when the threshold of a given performance metric is exceeded by the performance value. Further, as instructed by the administrator through the input device 214 at an arbitrary timing, this processing may be activated with the input of the identifier of a specific performance metric.

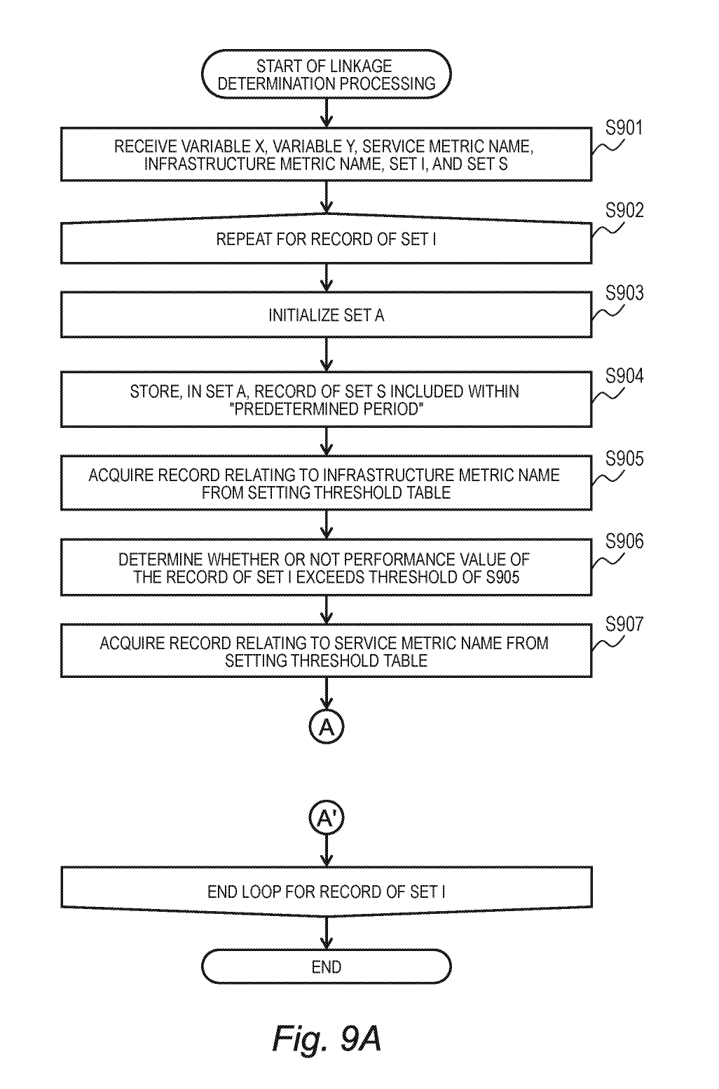

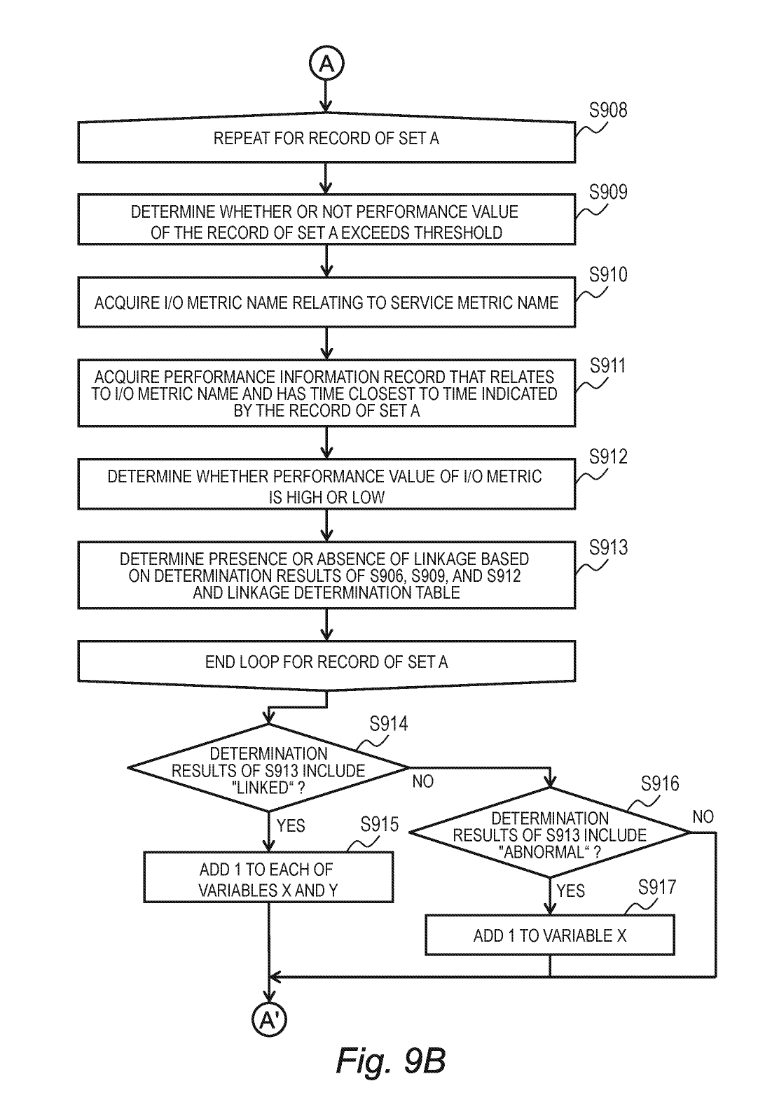

In the processing of FIG. 8, the threshold evaluation program 221 further calls and executes processing illustrated in FIG. 9A and FIG. 9B.

In Step S801, the threshold evaluation program 221 receives the metric name of an infrastructure for which the threshold is to be evaluated.

In Step S802, the threshold evaluation program 221 initializes a variable X and a variable Y each storing a numerical value (stores a value of 0 in each variable). Further, the threshold evaluation program 221 initializes a set S and a set I (sets the element of each set to 0).

In Step S803, the threshold evaluation program 221 refers to the service and infrastructure metric relationship table 233 for a record that has the field 502 storing the infrastructure metric name received in Step S801, and acquires all the identifiers stored in the service metric name 501.

In Step S804, the threshold evaluation program 221 conducts processing from Step S805 to Step S807 for each of the service metric names acquired in Step S803.

In Step S805, the threshold evaluation program 221 refers to the performance information table 231 to acquire all records that have the metric name 301 storing the service metric names, and stores the records in the set S. In order to shorten a processing time, the number of records acquired from the performance information table 231 may be reduced in this step. For example, only the records of the performance information table 231 that have the time 302 included within a specific period may be stored in the set S.

In Step S806, the threshold evaluation program 221 refers to the performance information table 231 to acquire all records that have the metric name 301 storing the infrastructure metric name received in Step S801, and stores the records in the set I. In order to shorten the processing time, the number of records acquired from the performance information table 231 may be reduced in this step. For example, only the records of the performance information table 231 that have the time 302 included within a specific period may be stored in the set I. Further, in order to shorten the processing time, only the records obtained when the value of the performance value 303 exceeds the threshold (when the performance changes from the normal status to an abnormal status or when the performance changes from the abnormal status to the normal status) may be acquired.

In Step S807, the threshold evaluation program 221 activates (“linkage determination processing” with inputs of the set I, the set S, the variable X, the variable Y, the service metric name, and the infrastructure metric name received in Step S801. The “linkage determination processing” is processing for determining how the timings at which the metrics indicated by the service metric name and the infrastructure metric name received in Step S801 exceed the thresholds are linked with each other, and recording a result thereof in the variable X and the variable Y. Details thereof are described with reference to FIG. 9A and FIG. 9B.

In Step S808, the threshold evaluation program 221 refers to the setting threshold table 232 for a record that has the metric name 401 storing the infrastructure metric name received in Step S801, and acquires the threshold 402 and the unit 403. Then, a record that has the metric name 701 storing the infrastructure metric name received in Step S801, the threshold 702 storing the acquired value of the threshold 402, the unit 703 storing the acquired value of the unit 403, and the evaluation value 704 storing a value obtained by calculating (variable Y)/(variable X) is added to or updated in the threshold evaluation table 235.

In Step S809, the threshold evaluation program 221 activates the display program 225, and the display program 225 refers to the threshold evaluation table 235 to display the evaluation result of the threshold including the evaluation value of the threshold at an arbitrary timing. The timing to display the evaluation value of the threshold may be immediately after the threshold evaluation program has ended. In another case, the evaluation of a relating threshold may be displayed together with an alert at the timing at which the administrator is notified of the alert when the performance value of a specific performance metric exceeds the threshold.

A specific example of the processing of FIG. 8 is as follows. For example, when the metric name “RAIDgroupA/Busy Rate” is received in Step S801, the threshold evaluation program 221 initializes each of the variable X, the variable Y, the set S, and the set I in Step S802, and then acquires the service metric names “iSCSIdiskA/Total Response Time Rate” and “iSCSIdiskB/Total Response Time Rate” from the service and infrastructure metric relationship table 233 in Step S803. A case is exemplified where the service metric name of interest is “iSCSIdiskA/Total Response Time Rate” in the iterative processing of Step S804. In Step S805, records 311 to 313 are acquired from the performance information table 231, and are stored in the set S. In Step S806, records 331 to 333 are acquired, and are stored in the set I. In Step S807, the “linkage determination processing” is activated. A case is exemplified where the variable X stores 100 and the variable Y stores 65 in Step S808. The threshold evaluation program 221 adds a record 711 to the threshold evaluation table 235. In Step S809, the threshold evaluation program 221 activates the display program 225, and presents the evaluation result to the administrator.

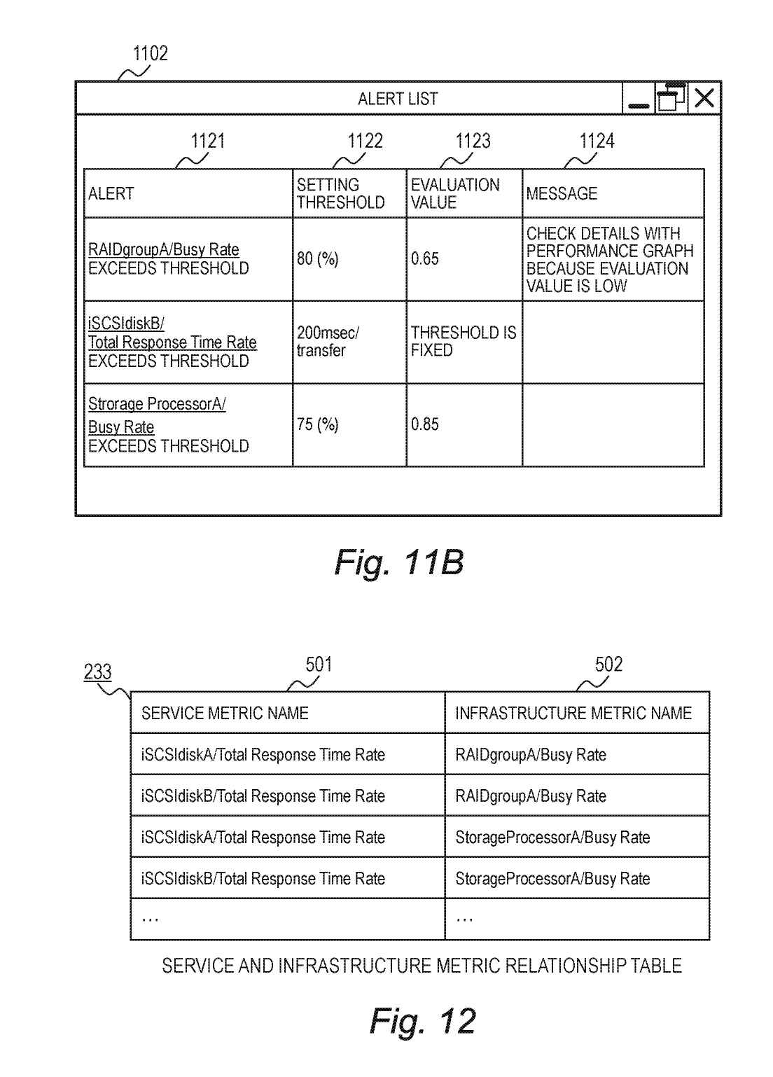

FIG. 11A is an illustration of an example of a threshold evaluation result screen 1101 for allowing the display program 225 to present information to the administrator through the output device 217.

The threshold evaluation result screen 1101 is an example of a screen displayed after the threshold evaluation program 221 calculates the evaluation value of the threshold. The threshold evaluation result screen 1101 may be formed of a field 1111 for displaying the metric name, a field 1112 for displaying the threshold, and a field 1113 for displaying the evaluation value of the threshold. Further, the threshold evaluation result screen 1101 may include a field 1114 for displaying a message for presenting whether or not to review the threshold for each metric. The display program 225 may include processing for displaying, in the field 1114, a message for informing that “review of threshold is recommended” when the evaluation value of the threshold is equal to or smaller than a predetermined value. For example, when the evaluation value, of the threshold is equal to or larger than 0.0 and smaller than 0.8, a message that “the review of the threshold is recommended” is displayed, and when the evaluation value is equal to or larger than 0.8, a message that “the threshold is sufficiently effective” is displayed. Those fields 1111 to 1114 may be provided and displayed for each metric. Further, the threshold evaluation result screen 1101 may include a change button 1115. When the change button 1115 is operated, the screen may shift to a screen for changing the threshold of the specified metric.

Further, an alert list screen 1102 illustrated in FIG. 11B is an example of a screen for allowing the display program 225 to display alert information generated by an alert management program that is not shown in FIG. 2A or FIG. 2B. The alert management program may be configured as a program for generating the alert information in order to notify the administrator of the abnormal status when the performance value of the management target acquired by the performance information acquisition program 224 exceeds the threshold. The alert list screen 1102 may be formed of a field 1121 for displaying the alert information, a field 1122 for displaying the threshold set for the metric included in the alert information, and a field 1123 for displaying the evaluation value of the set threshold. The alert information may include the metric name having the threshold exceeded. The alert list screen 1102 may include a field 1124 for displaying a message for presenting whether or not the administrator needs to analyze whether or not each alert is really an effective alert. The display program 225 may include processing for displaying, in the field 1124, a message for informing that “detailed analysis of alert information is recommended” when the evaluation value of the threshold is equal to or smaller than the predetermined value. For example, when the evaluation value of the threshold is equal to or larger than 0.0 and smaller than 0.8, a message that “check details with performance graph” is displayed. Further, when the metric name displayed in the field 1121 is selected, the screen may shift to a screen for displaying the performance graph of the selected metric.

FIG. 9A and FIG. 9B are flowcharts for illustrating an example of the linkage determination processing executed by the threshold evaluation program 221 in Step S807.

In the “linkage determination processing”, it is determined how the timing at which the specified service metric exceeds the threshold and the timing at which the infrastructure metric exceeds the threshold are linked with each other.

In Step S901, the linkage determination processing receives the variable X, the variable Y, the service metric name, the infrastructure metric name, and the set I and the set S, which store the records of the performance information table 231, from the threshold evaluation program 221.

In Step S902, the linkage determination processing conducts processing from Step S903 to Step S917 for each of the records stored in the set I.

In Step S903, the linkage determination processing initializes a set A (sets the element to 0).

In Step S904, the linkage determination processing extracts a record included within a “predetermined period”, which starts at the value of the time 302 indicated by the record of the set I, from among the records stored in the set S, and stores the extracted record in the set A. The “predetermined period” may be, for example, a period “from a time earlier by the collection interval of the performance information on the infrastructure metric until a time later by the collection interval of the performance information on the service metric” than a given time. A case where the record of the set I is a record 332 shown in FIG. 3 with the infrastructure metric name being “RAIDgroupA/Busy Rate” and the service metric name being “iSCSIdiskA/Total Response Time Rate” is taken as an example. It is understood from the time 302 of the records 331 to 333 that the collection interval of the performance information on “RAIDgroupA/Busy Rate” is 5 minutes. In the same manner, it is understood from the records 311 to 313 that the collection interval of the performance information on “iSCSIdiskA/Total Response Time Rate” is 1 minute. The time 302 of the record 332 is “2014/01/01;0:05”, and hence the “predetermined period” is set to 5 minutes earlier and 1 minute later than “2014/01/01;0:05”, that is, a period from 2014/01/01;0:00 to 2014/01/01;0:06. In addition, the “predetermined period” may be a fixed period set by the administrator or a creator of the threshold evaluation program 221. Further, the record stored in the set A is not only the record included within the “predetermined period”, but may also be a record having a time closest to the value of the time 302 indicated by the record of the set I.

In Step S905, the linkage determination processing acquires a record that has the field 501 storing the received infrastructure metric name from the setting threshold table 232.

In Step S906, the linkage determination processing determines based on the record acquired in Step S905 whether or not the performance value 303 of the record of the set I exceeds the threshold to exhibit an abnormal status.

In Step S907, the linkage determination processing acquires a record that has the metric name 401 storing the received service metric name from the setting threshold table 232.

In Step S908, the linkage determination processing conducts processing from Step S909 to Step S913 for each of the records stored in the set A.

In Step S909, the linkage determination processing determines based on the record of the setting threshold table 232 acquired in Step S906 whether or not the performance value 303 of the record of the set A exceeds the threshold to exhibit an abnormal status.

In Step S910, the linkage determination processing refers to the service and I/O metric relationship table 234 for the record relating to the received service metric name, and acquires an I/O metric name 602.

In Step S911, the linkage determination processing acquires, from the performance information table 231, a record that has the same metric name 301 as the I/O metric name 602 acquired in Step S909 and the time 302 closest to the time 302 of the record of the set A.

In Step S912, the linkage determination processing determines whether the performance value 303 of the record of the I/O metric acquired in Step S911 is high or low. As a determination method as to whether or not the performance value 303 is high or low, for example, the performance values of the I/O metric of interest corresponding to a predetermined period are acquired from the performance information table, the acquired performance values are sorted in ascending order, and when the value is included within the top x % (for example, 80%), the performance value 303 may be determined to be “high”. The “predetermined period” may be, for example, a period indicated by a minimum value and a maximum value of the time 302 of a record group of the set S.

Further, as another example of the determination method, the following method may be used to determine whether or not the performance value 303 is high or low. All the performance values of the service metric are acquired from the performance information table 231, and the time 302 at which the threshold is exceeded to exhibit an abnormal status is extracted. The performance value 303 of the record of the I/O metric having the time 302 closest to each of the extracted times 302 is extracted from the performance information table 231. When a mean value of the extracted performance values 303 is exceeded, the performance value 303 of the record of the I/O metric acquired in Step S911 is determined(to be “high”.

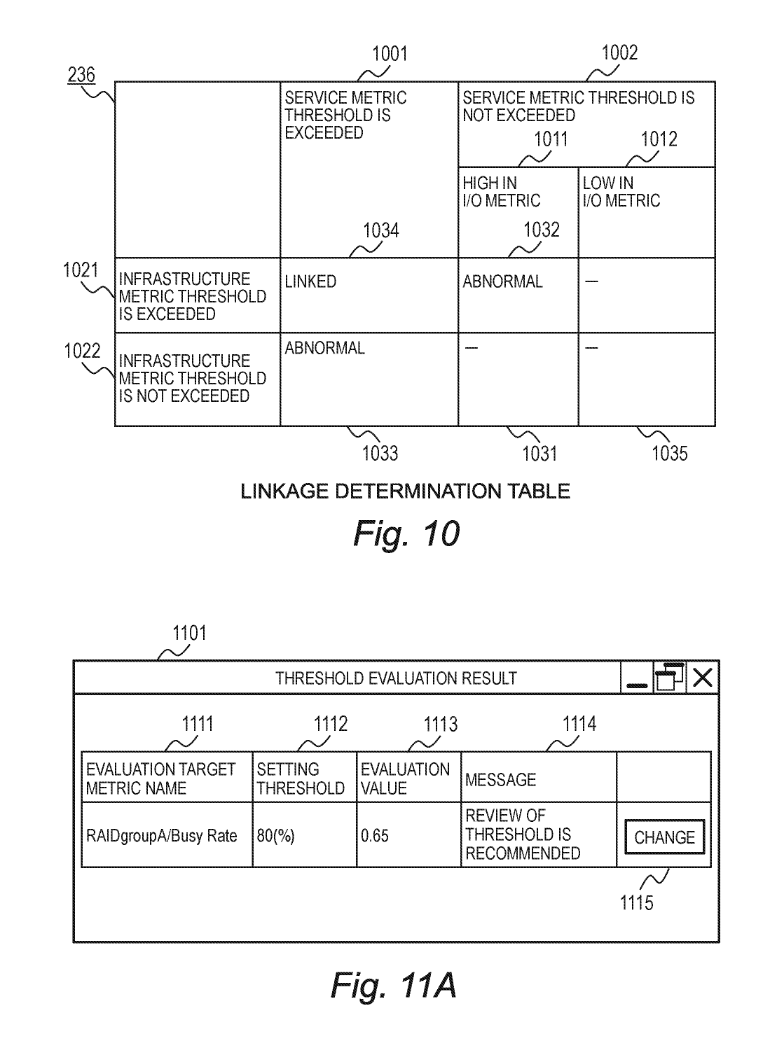

In Step S913, the linkage determination processing determines the presence or absence of the linkage between the service metric and the infrastructure metric based on the determination results of Steps S906, S909, and S912 illustrated in FIG. 9A and FIG. 9B and the linkage determination table 236 shown in FIG. 10.

In FIG. 10, a specific example of the linkage determination table 236 is shown.

The linkage determination table 236 is data having a table format used for determining the linkage between the service metric and the infrastructure metric as any one of “linked”, “abnormal”, and “² based on the determination results of Steps S906, S909, and S912.

In this embodiment, the evaluation value of the threshold is determined based on whether or not the timing at which the performance metric of the infrastructure exceeds the threshold and the timing at which the performance metric of the service relating thereto exceeds the threshold are linked with each other.

Further, the input or output is not conducted from the service to the infrastructure in the first place when the performance value of the infrastructure metric exceeds the threshold, the performance value of the service metric does not exceed the threshold, and the value of the I/O metric relating to the service metric is low. It is therefore determined that the presence or absence of the linkage is unknown.

For example, the I/O metric is the disk I/O of the server when the disk response time of the server is set as the service metric and the utilization of the storage RAID group is set as the infrastructure metric.

When the disk response time and the utilization exceed the threshold at the same timing, it is determined that the linkage is present. Meanwhile, when the utilization does not exceed the threshold even with the disk response time exceeding the threshold, it is determined that the threshold of the utilization is abnormal. Further, it is determined that the presence or absence of the linkage is unknown when the disk response time does not exceed the threshold and the disk I/O of the server is low even with the utilization exceeding the threshold. This is because the disk response time is zero when there is no disk access occurring in the first place even when the storage RAID group deteriorates in performance, and hence the case where the disk I/O is low does not provide data effective for determining the presence or absence of the linkage.

It is determined which of a field 1001 and a field 1002 of the linkage determination table 236 is to be referred to based on the result of the “determination as to whether or not the performance value of the service metric exceeds the threshold” conducted in Step S909. Further, it is determined which of a field 1011 and a field 1012 is to be referred to based on the result of the “determination as to whether or not the performance value of the I/O metric is high” conducted in Step S912. In addition, it is determined which of a field 1021 and a field 1022 is to be referred to based on the result of the “determination as to whether or not the performance value of the infrastructure metric exceeds the threshold” conducted in Step S906.

In this embodiment, the linkage determination table 236 stores identification information of any one of “linked”, “abnormal”, and “-”. The identification information “linked” indicates that the infrastructure metric and the service metric are linked with each other. The identification information “abnormal” indicates that the infrastructure metric and the service metric are not linked with each other. The identification information “-” indicates that it is unknown whether or not the infrastructure metric and the service metric are linked with each other.

In Step S913, the above-mentioned linkage determination table 236 is used to acquire the determination result of any one of “linked”, “abnormal”, and “-” from the linkage determination table 236 based on the determination results of Steps S906, S909, and S912.

The description is made with reference to FIG. 9B again.

In Step S914, the linkage determination processing determines whether or not the determination results of Step S913 that has been repeatedly executed include “linked” even at least once. When the result of the above-mentioned determination is true (the determination result includes “linked”) (YES in S914), the processing advances to Step S915. When the result of the above-mentioned determination is false (the determination result does not include “linked”) (NO in S914), the processing advances to Step S916.

In Step S915, the linkage determination processing adds a numerical value of 1 to each of the variable X and the variable Y.

In Step S916, the linkage determination processing determines whether or not the determination results of Step S913 that has been repeatedly executed include “abnormal” even at least once. When the result of the above-mentioned determination is true (the determination result includes “abnormal”) (YES in S916), the processing advances to Step S917. When the result of the above-mentioned determination is false (the determination result does not include “abnormal”) (NO in S916), the processing continues to execute the iterative processing of Step S902.

In Step S917, the linkage determination processing adds a numerical value of 1 to the variable X.

In this embodiment, it is determined that the service metric and the infrastructure metric are linked with each other when the performance value of the service metric exceeds the threshold at the same time when the performance value of the infrastructure metric exceeds the threshold. However, it may be determined that the service metric and the infrastructure metric are linked with each other when the -performance value of the service metric does not exceed the threshold and the performance value of the infrastructure metric does not exceed the threshold. In other words, it can be determined that the service metric and the infrastructure metric are linked with each other when the performance value of the service metric and the performance value of the infrastructure metric exhibit the same determination result for the respective thresholds. In this case, “linked” may be stored in a cell 1031 or two cells of the cell 1031 and a cell 1035 of the linkage determination table 236.

Further, in this case, in the determination of the presence or absence of the linkage between the service metric and the infrastructure metric, the determination that “both the performance values do not exceed the thresholds” may be given a priority lower than the determination that “both the performance values exceed the thresholds” and the determination of “abnormal”.

For example, the following processing may be conducted in Step S914 and the subsequent steps.

In Step S914, it is determined whether or not the determination result of Step S913 includes a cell 1034 of the linkage determination table 236. When the determination result is true, the processing advances to Step S915, and when the determination result is false (the determination result of Step S913 does not include the cell 1034 of the linkage determination table 236), the processing advances to Step S916. In Step S916, it is determined whether or not the determination result of Step S913 includes “abnormal”. When the determination result is true, the processing advances to Step S917, and when the determination result is false (the determination result of Step S913 does not include “abnormal”), the processing advances to the following additional step that is not illustrated in FIG. 9A or FIG. 9B. In the additional step, it is determined whether or not the determination result of Step S913 includes the cell 1031 or the cell 1035 of the linkage determination table 236. When the determination result is true, (the determination result of Step S913 includes the cell 1031 or the cell 1035 of the linkage determination table 236), the processing advances to Step S915, and when the determination result is false (the determination result of Step S913 includes neither of the cell 1031 and the cell 1035 of the linkage determination table 236), the processing continues to execute the iterative processing of Step S902.

In this embodiment, it is not determined that the linkage is present when the performance metric of the service does not exceed the threshold and the performance value of the infrastructure metric does not exceed the threshold. This is because there is a fear that, when the linkage determination table 236 is used based on the performance value for general performance monitoring, the cell 1031 and the cell 1035 may, be selected extremely often, and the evaluation value may become an extremely larger value.

The description of this embodiment is directed to the processing conducted until the evaluation value of the threshold is calculated, but when the evaluation value is low, the recommended threshold may be presented. For example, a range of the recommended threshold calculated by the following method may be presented. The presentation of the range of the recommended threshold can facilitate the user's determination in setting a new threshold.

In Step S913, all pieces of identification information on the cells of the linkage determination table 236 referred to when “abnormal” is determined based on the linkage determination table 236 are recorded. In other words, it is recorded which of a cell 1032 and a cell 1033 shown in FIG. 10 has been referred to. At the same time, the metric name 301 and the performance value 303 within the record of the set I currently of interest are recorded. When the recommended threshold of a given infrastructure metric y is set to a variable x, the performance value 303 and the identification information on the cell relating to the infrastructure metric y are extracted from the recorded information. Then, a range of x is calculated based on the following simultaneous inequalities.
x<(performance value obtained by referring to the cell 1032)
x>(performance value obtained by referring to the cell 1033)

In this embodiment, the I/O metric is used to evaluate the threshold of the service metric, but the threshold of the service metric may be evaluated without using the I/O metric. In this case, the processing from Step S910 to Step S912 may be omitted, and further in Step S913, the presence or absence of the linkage may be determined without referring to the field 1012 of the linkage determination table 236.

Next, a specific example of the processing of FIG. 9A and FIG. 9B is described.

For example, in Step S901, the variable X=0, the variable Y=0, the infrastructure metric name “RAIDgroupA/Busy Rate”, the service metric name “iSCSIdiskA/Total Response Time Rate”, the set I (records 331 to 333), and the set S (records 311 to 313) are received. An example in which the record of the set I of interest is the record 332 in the iterative processing of Step S902 is described below.

The linkage determination processing initializes the set A in Step S903, and then stores the records 311 and 312 in the set A in Step S904. In Step S905, a record 412 is acquired from the setting threshold table 232. In Step S906, the linkage determination processing determines that the “infrastructure metric threshold is exceeded” based on the threshold of the record 412 being “80(%)” and the performance value of the record 312 being “85(%)”.

In Step S907, a record 411 is acquired from the setting threshold table. An example in which the record of the set A of interest is the record 311 in the iterative processing of Step S908 is described below. In Step S909, the linkage determination processing determines that the “service metric threshold is not exceeded” based on the threshold of the record 411 being “200 (milliseconds/transfer)” and the performance value of the record 311 being “80 (milliseconds/transfer)”. In Step S910, “iSCSIdiskA/IO Rate” relating to “iSCSIdiskA/Total Response Time Rate” is acquired from the service and I/O metric relationship table 234. In Step S911, the record 321 that has the metric name 301 storing “iSCSIdiskA/IO Rate” and the time 302 being closest to the time “2014/01/01;0:00” of the record 311 is acquired from, the performance information table 231.

An example in which the performance value 303 of the record 321 is 15, determined to be “high in I/O metric” in Step S912 is described below. In Step S913, the determination result of “abnormal” is derived based on the linkage determination table 236, the determination results that the “infrastructure metric threshold is exceeded” in Step S906 and that the “service metric threshold is not exceeded” in Step S909, and the determination result of being “high in I/O metric” in Step S912. When “NO” is determined in Step S914 and “YES” is determined in Step S916, “1” is stored in the variable X, and the variable Y remains “0”.

This embodiment presupposes that the threshold is set for the performance metric of each of the apparatus and the parts thereof that form the IT system, but the threshold may be set for each of the types of the apparatus and the parts thereof. In that case, the threshold may be evaluated for each of the types of the apparatus and the parts thereof, and the evaluation value may be a mean value, a maximum value, or a minimum value of the evaluation value of all apparatus (or parts thereof) belonging to the type. In another case, variables X and Y of all the apparatus (or parts thereof) belonging to the type, which are to be used in Step S808, may be each summed up to obtain, (total sum of Y)/(total sum of X) as the evaluation value.

Further, in this embodiment, a combination of the service metric and the infrastructure metric that are correlating with each other is fixed. However, the combination of the service metric and the infrastructure metric that are correlating with each other may change when the configuration of the IT system is changed. For example, the RAID group relating to the iSCSI disk of the server may be changed by a migration function of a volume of the storage or the like. In this case, a period during which the correlation indicated by each record of the service and infrastructure metric relationship table 233 is effective may also be recorded in the table, and the presence or absence of the linkage between the service metric and the infrastructure metric may be determined based on the performance information included in the period, to thereby determine the evaluation value of the threshold of the infrastructure metric.

Further, the correlation between the infrastructure metric and the service metric exhibited before and after the configuration of the IT system is changed may be recorded in the service and infrastructure metric relationship table 233, and the threshold of the infrastructure metric may be evaluated for both periods before the change and after the change.

Further, this embodiment is described by taking an example in which the same threshold is set for all the service metrics having the same metric type. The metrics having the same metric type are, for example, metrics having the performance measured by the same method on different infrastructures, e.g., “iSCSIdiskA/Total Response Time Rate” and “iSCSIdiskB/Total Response Time Rate”. However, in general, different thresholds may be set for the service metrics having the same type. In this case, in the determination as to whether or not the infrastructure metric and the service metric are linked with each other, a priority may be given to the service metric having the “strictest” threshold. This is because the exceeding of the threshold by the infrastructure metric does not need to be linked with the exceeding of the threshold by the service metric that does not have the “strictest” threshold as long as the exceeding of the threshold by the infrastructure metric is linked with the exceeding of the threshold by the service metric having the “strictest” threshold. The “strict” threshold represents, for example, such a threshold as to become a “stricter” threshold as the threshold becomes smaller in the performance metric in which the performance value larger than the threshold is regarded as being abnormal. When the service metrics have the same type relating to the infrastructure metric and have different thresholds, the following processing may be carried out to preferentially reflect the service metric having the “strictest” threshold in the evaluation value of the infrastructure metric.

The following processing is conducted before Step S913 of FIG. 9B is executed. (1) All the service metric names relating to the infrastructure metric name received in Step S901 and having the same metric type as the service metric name received in Step S901 are acquired from the service and infrastructure metric relationship table 233. (2) With reference to the setting threshold table 232, the thresholds 402 of a group of the acquired service metric names are compared with the threshold 402 of the received service metric name to determine whether or not the received service metric name has the “strictest” threshold. When the determination result is false (that is, the received service metric name does not have the “strictest” threshold), another linkage determination table 236 including the cell 1032 storing “-” is used to determine the presence/absence of the linkage in Step S913. Therefore, when the evaluation becomes inappropriate, the evaluation of the threshold can be avoided, and the linkage determination table 236 can be switched to another linkage determination table to evaluate the threshold.

With the above-mentioned method, the threshold of the infrastructure metrics can be evaluated even when different thresholds are set for the service metrics having the same metric type.

As described above, according to the first embodiment, the evaluation value of the threshold of the infrastructure metric is calculated based on the linkage between the timings at which the service metric and the infrastructure metric exceed the threshold so as to raise the evaluation when both change simultaneously with the same inclination. Therefore, it is possible to present to the administrator whether or not to review the threshold setting and whether or not to verify the notified alert again.

Further, the evaluation value of the threshold of the infrastructure metric is calculated through use of a magnitude of the performance value of the I/O metric in addition to the linkage between the timings at which the service metric and the infrastructure metric exceed the thresholds. Therefore, the threshold of the infrastructure metric does not need to be evaluated when the performance value of the I/O metric is low, and it is possible to improve accuracy in evaluation.

Further, in regard to whether the performance value of the I/O metric is high or low, the performance value included in the values within the top x % (for example, 80%) among the performance values of the I/O metric within a predetermined period is determined to be “high”. Therefore, it is possible to easily determine whether the performance value of the I/O metric is high or low.

Further, the mean value of the performance value of the I/O metric having the time closest to each time at which the performance value of the service metric exceeds the threshold is calculated, and when the mean value is exceeded, the performance value of the I/O metric is determined to be “high”. Therefore, it is possible to determine whether the performance value of the I/O metric is high or low with high precision.

Further, when the administrator is notified of the alert indicating that the set threshold is exceeded, the evaluation value of the threshold is also displayed, to thereby be able to present whether or not the generated alert is reliable or whether or not the administrator needs to inspect the performance information in detail through direct examination. This allows the administrator to determine whether or not to review the set threshold. Further, it is possible to determine a method of handling and analyzing the generated alert.

### Second Embodiment

Next, a second embodiment of this invention is described. Differences from the first embodiment are mainly described below, and descriptions of the equivalent components, the programs having the equivalent functions, and the tables having the equivalent items are omitted or simplified.

In the first embodiment, the evaluation value of the threshold is calculated based on the linkage between the timing at which the service metric and the infrastructure metric that relate to each other exceed the thresholds. However, in the general performance monitoring, there is a case where the timing at which the service metric exceeds the threshold does not need to be the same as the timing at which a given infrastructure metric exceeds the threshold. Specifically, there is a case where the service metric relates to a plurality of infrastructure metrics and it suffices that the service metric is linked with at least one of the infrastructure metrics.

For example, in the first embodiment, the infrastructure metric relating to the service metric “disk response time of the server” is only the “utilization of the RAID group”. The reason that the two metrics are defined as relating to each other is that the response time of the disk of the server on which the volume of the RAID group is mounted is lowered due to the deterioration in performance of the RAID group. However, the deterioration in performance of the “disk response time of the server” may actually be caused by the deterioration in performance of, for example, a storage processor used by the disk instead of the RAID group. In this case, it suffices that the timings at which any one of the infrastructure metrics and the service metric exceed the thresholds are linked with each other. Therefore, in order to evaluate the threshold of one given infrastructure metric, it may also be added to the evaluation item whether or not another infrastructure metric relating to the service metric exceeds the threshold in addition to the relating service metrics.

The second embodiment is described by taking an example in which, when the threshold of one given infrastructure metric is evaluated, whether or not another infrastructure metric exceeds the threshold is also reflected in the evaluation value.

In the description of the second embodiment, the performance information table 231, the setting threshold table 232, the service and I/O metric relationship table 234, and the threshold evaluation table 235 that are the same as those of the first embodiment are used. The structures of the respective tables are the same as those of the first embodiment.

In FIG. 12, an example of a configuration of the service and infrastructure metric relationship table 233 according to the second embodiment is shown.

The structure of the service and infrastructure metric relationship table 233 according to the second embodiment is substantially the same as the structure of the service and infrastructure metric relationship table 233 according to the first embodiment. In order to describe the second embodiment, the stored data is different from that of the first embodiment.

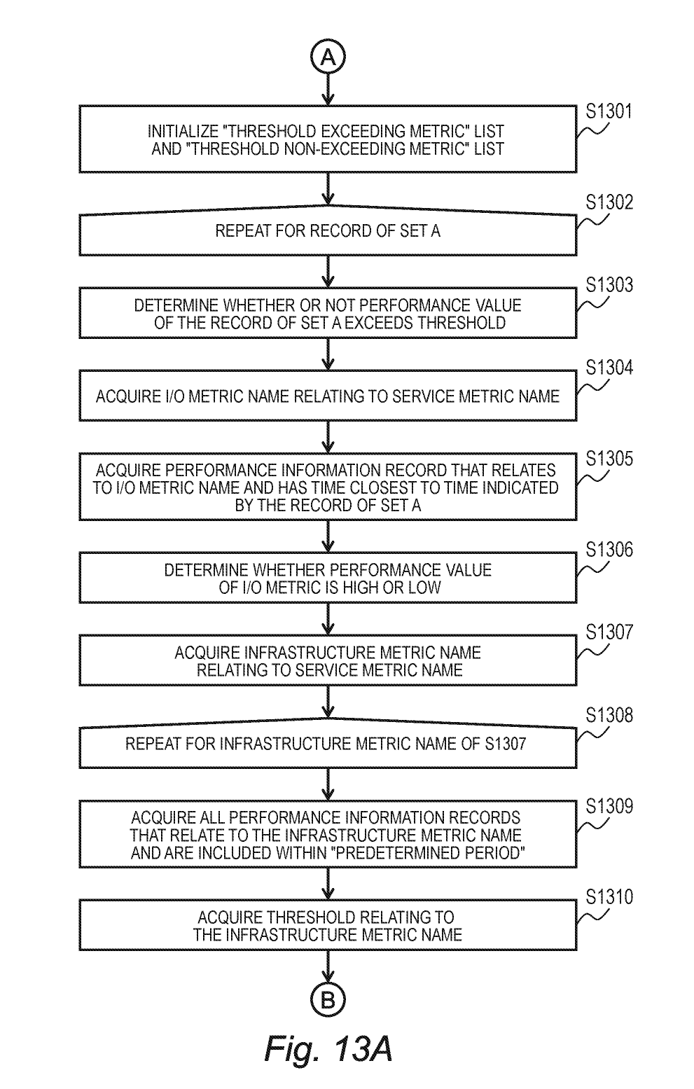

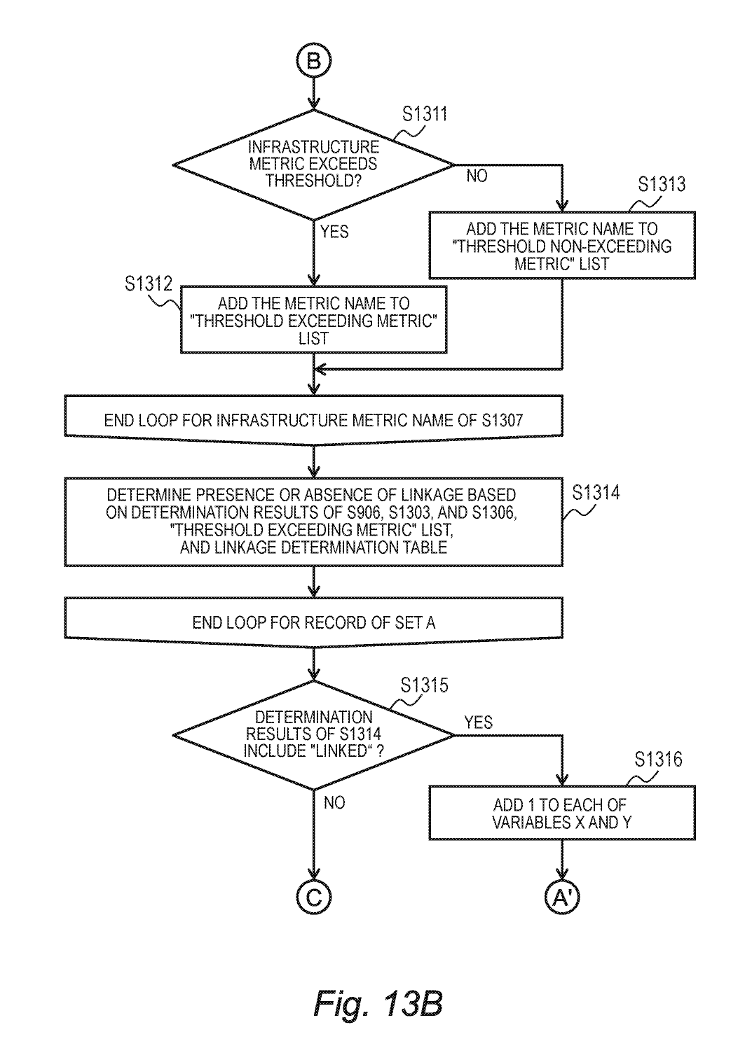

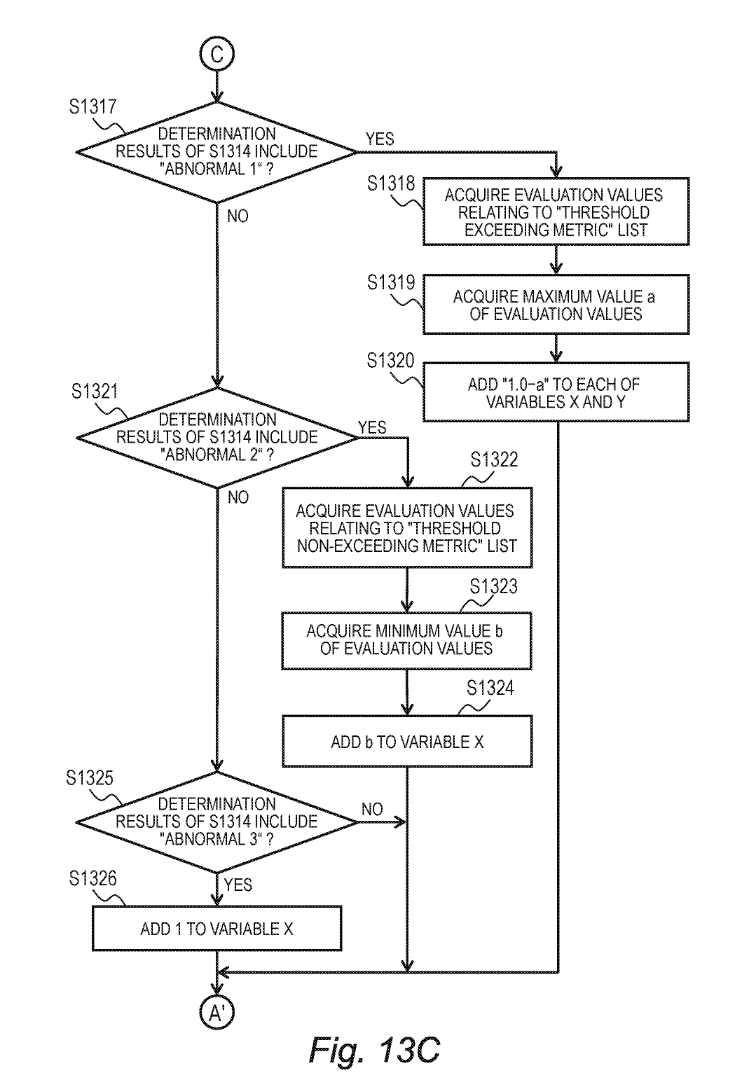

FIG. 13A, FIG. 13B, and FIG. 13C are flowcharts of an example of the linkage determination processing executed in Step S807 of the threshold evaluation program 221 according to the second embodiment. The start timing of the threshold evaluation program 221 may be the timing described in the first embodiment. The processing of the threshold evaluation program 221 according to the second embodiment may be conducted in the same manner as the processing from Step S801 to Step S809 of FIG. 8 according to the first embodiment. Further, the linkage determination processing according to the second embodiment executes the processing from Step S901 to Step S907 of FIG. 9A in the same manner as in the first embodiment. Hence, the description of the processing from Step S901 to Step S907 is omitted. Therefore, the processing of Step S1301 illustrated in FIG. 13A is processing executed after Step S907 of FIG. 9A.

In Step S1301, the linkage determination processing initializes a “threshold exceeding metric” list and a “threshold non-exceeding metric” list (sets all the elements to zero). The two lists serve as memory areas for recording a plurality of metric names in processing described later.

In Step S1302, the linkage determination processing conducts processing from Step S1303 to Step S1314 for each of the records stored in the set A.

The processing from Step S1303 to Step S1306 is the same as the processing from Step S909 to Step S912 according to the first embodiment, and hence the description thereof is omitted.

In Step S1307, the linkage determination processing refers to the service and infrastructure metric relationship table 233 for a record that has the field 501 storing the service metric name received in Step S901, and acquires all the infrastructure metric names 502. However, the infrastructure metric name received in Step S901 is excluded from the infrastructure metric names 502 to be acquired.

In Step S1308, the linkage determination processing conducts the processing from Step S1309 to Step S1313 for each of the infrastructure metric names acquired in Step S1307.

In Step S1309, the linkage determination processing acquires, from the performance information table 231, all the records that have the metric name 301 storing the above-mentioned infrastructure metric name and are included within the predetermined period that starts at the time 302 indicated by the record of the set A. The definition of the “predetermined period” may be the same as, for example, the example of the definition of the “predetermined period” described in Step S904 according to the first embodiment.

In Step S1310, the linkage determination processing acquires a record that has the metric name 401 storing the above-mentioned infrastructure metric name from the setting threshold table 232.

In Step S1311, the linkage determination processing determines whether or not one or more performance values among the performance values 303 of all the records acquired in Step S1309 exceed the threshold indicated in the record acquired in Step S1310. When the result of the above-mentioned determination is true (one or more performance values exceed the threshold) (YES in S1311), the processing advances to Step S1312, and when the result of the above-mentioned determination is false (none of the performance values exceeds the threshold) (NO in S1311), the processing advances to Step S1313.

In Step S1312, the linkage determination processing adds the above-mentioned metric name to the “threshold exceeding metric” list.

In Step S1313, the linkage determination processing adds the above-mentioned metric name to the “threshold non-exceeding metric” list.

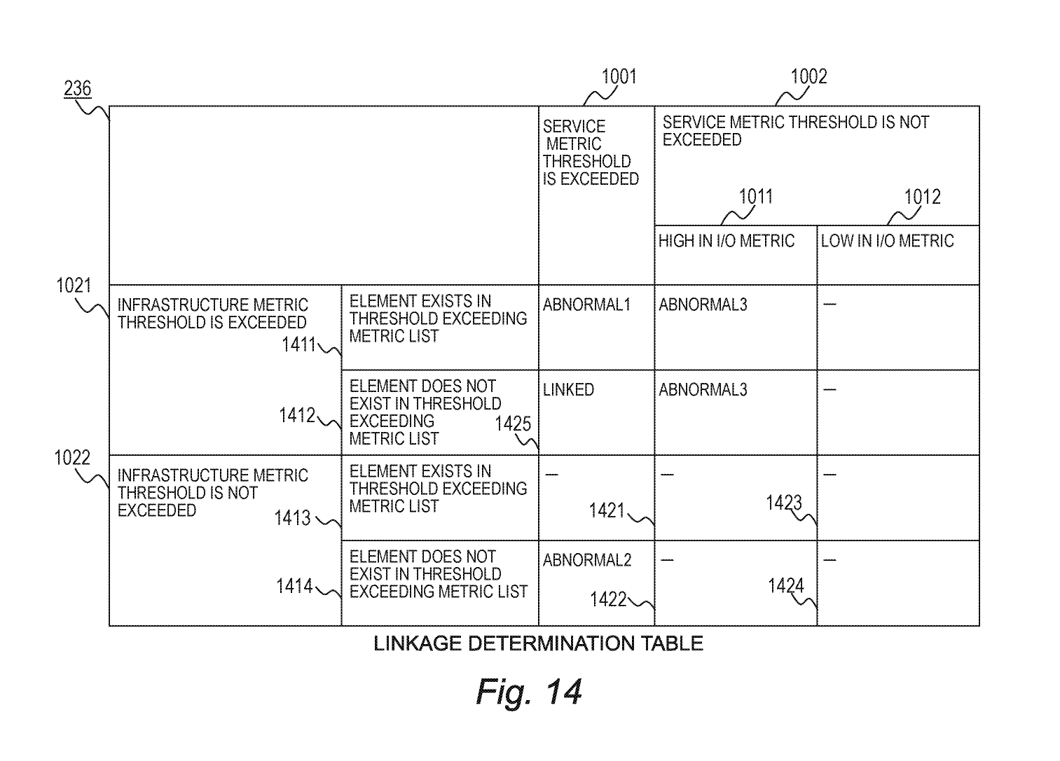

In Step S1314, the linkage determination processing determines the presence or absence of the linkage from the linkage determination table 236 shown in FIG. 14 based on the determination results of Steps S906, S1303, and S1306 and the value stored in the “threshold exceeding metric” list.

In FIG. 14, a specific example of the linkage determination table 236 of the second embodiment is shown.

The linkage determination table 236 is a table used for determining the linkage between the service metric and the infrastructure metric as any one of “linked”, “abnormal 1”, “abnormal 2”, “abnormal 3”, and “-” based on the determination results of Steps S906, S1303, and S1306 and the value stored in the “threshold exceeding metric” list.

In the first embodiment, the threshold is evaluated from the three viewpoints of “whether or not the infrastructure metric exceeds the threshold”, “whether or not the service metric exceeds the threshold”, and “whether or not the value of the I/O metric of the service is high”. In the second embodiment, the threshold is evaluated from the viewpoint of “whether or not the performance value of another infrastructure metric relating to the service metric of interest exceeds the threshold” in addition to the viewpoints of the first embodiment. Therefore, when there exists an element in the “threshold exceeding metric” list in Step S1312, it can be determined that the performance value of another infrastructure metric exceeds the threshold.

As described at the beginning of the description of the second embodiment, the new viewpoint is added in order to allow an analysis of the case where the service metric relates to a plurality of infrastructure metrics and it suffices that the service metric is linked with at least one infrastructure metric.

The fields 1001, 1002, 1011, 1012, 1021, and 1022 of FIG. 14 are the same fields as those of the linkage determination table 236 according to the first embodiment shown in FIG. 10. In addition, the linkage determination table 236 according to the second embodiment may include fields 1411 to 1414. It is determined which of the fields 1411 to 1414 the “linkage determination processing” is to refer to based on the determination result of “whether or not there is an element in the threshold exceeding metric list”.

Further, the identification information of any one of “linked”, “abnormal”, and “-” is stored in the linkage determination table 236 in the first embodiment, while in the second embodiment, identification information of any one of “linked”, “abnormal 1”, “abnormal 2”, “abnormal 3”, and “-” is stored. The identification information “linked” and the identification information “-” have the same meaning as those of the first embodiment. Further, the identification information “abnormal” of the first embodiment and the identification information “abnormal 3” of the second embodiment have the same meaning.

The identification information “abnormal 1” is referred to when the service metric and the infrastructure metric to be evaluated exceed the thresholds and another relating infrastructure metric also exceeds the threshold. In this case, it cannot be determined which infrastructure has deteriorated in performance to cause deterioration in service performance. In short, an inappropriate threshold may be set for any one of the threshold of the infrastructure metric to be evaluated and the threshold of another infrastructure metric, to thereby exhibit a state in which “the threshold is exceeded”. Therefore, when “abnormal 1” is referred to, the evaluation value of another infrastructure metric that exceeds the threshold is reflected in the evaluation value of the infrastructure metric to be evaluated. Specifically, a value to be added to the evaluation value when the identification information “linked” is determined is reduced by the evaluation value of another infrastructure metric.

The identification information “abnormal 2” is referred to when the performance value of the service metric exceeds the threshold but when none of the relating infrastructure metrics exceeds the threshold. In this case, it cannot be determined which infrastructure metric has an inappropriate threshold. In other words, the threshold not of the infrastructure metric to be evaluated but of another infrastructure metric may be inappropriate. Therefore, when “abnormal 2” is referred to, the evaluation value of another infrastructure metric that has not exceeded the threshold is reflected in the evaluation value of the infrastructure metric to be evaluated. Specifically, a value to be subtracted from the evaluation value when the identification information “abnormal 3” is determined is reduced by the evaluation value of another infrastructure metric.

In Step S1314, the above-mentioned linkage determination table 236 is used to acquire the determination result of any one of “linked”, “abnormal 1”, “abnormal 2”, “abnormal 3”, and “-” from the linkage determination table 236 based on the determination results of Steps S906, S1303, and S1306.

The description is made with reference to FIG. 13B again.

In Step S1315, the linkage determination processing determines whether or not the determination results of Step S1314 that has been repeatedly executed include “linked” even at least once. When the result of the above-mentioned determination is true (the determination result includes “linked”) (YES in S1315), the processing advances to Step S1316. When the result of the above-mentioned determination is false (the determination result does not include “linked”) (NO in S1315), the processing advances to Step S1317.

In Step S1316, the linkage determination processing adds a numerical value of 1 to each of the variable X and the variable Y.

In Step S1317, the linkage determination processing determines whether or not the determination results of Step S1314 that has been repeatedly executed include “abnormal 1” even at least once. When the result of the above-mentioned determination is true (the determination result includes “abnormal 1”) (YES in S1317), the processing advances to Step S1318. When the result of the above-mentioned determination is false (the determination result does not include “abnormal 1”) (NO in S1317), the processing advances to Step S1321.

In Step S1318, the linkage determination processing refers to the threshold evaluation table 235 for the record that has the metric name 701 storing the metric name stored in the “threshold exceeding metric” list, and acquires all the evaluation values 704.

In Step S1319, the linkage determination processing acquires a maximum value a of the evaluation values 704 acquired in Step S1318.

In Step S1320, the linkage determination processing adds “1.0−(maximum value a)” to each of the variable X and the variable Y.

In Step S1321, the linkage determination processing determines whether or not the determination results of Step S1314 that has been repeatedly executed include “abnormal 2” even at least once. When the result of the above-mentioned determination is true (the determination result includes “abnormal 2”) (YES in S1321), the processing advances to Step S1322, and when the result of the above-mentioned determination is false (the determination result does not include “abnormal 2”) (NO in S1321), the processing advances to Step S1325.

In Step S1322, the linkage determination processing refers to the threshold evaluation table 235 for the record that has the metric name 701 storing the metric name stored in the “threshold non-exceeding metric” list, and acquires all the evaluation values 704.

In Step S1323, the linkage determination processing acquires a minimum value b of the evaluation values 704 acquired in Step S1322.

In Step S1324, the linkage determination processing adds “minimum value b” to the variable X.

In Step S1325, the linkage determination processing determines whether or not the determination results of Step S1314 that has been repeatedly executed include “abnormal 3” even at least once. When the result of the above-mentioned determination is true (the determination result includes “abnormal 3”) (YES in S1325), the processing advances to Step S1326, and when the result of the above-mentioned determination is false (the determination result does not include “abnormal 3”) (NO in S1325), the processing continues to execute the iterative processing of Step S902.

A specific example of the processing of FIG. 13A, FIG. 13B, and FIG. 13C is as follows. For example, it is assumed that, in the flowchart illustrated in FIG. 9A executed before the flowchart illustrated in FIG. 13A, the infrastructure metric name “RAIDgroupA/Busy Rate” and the service metric name “iSCSIdiskA/Total Response Time Rate” are received in Step S901, the record 332 is focused on in the iterative processing of Step S902, the records 311 to 313 is stored in the set A in Step S904, it is determined in Step S906 that the “infrastructure metric threshold is exceeded”, and the record 411 is acquired in Step S907.

In Step S1301, the linkage determination processing initializes the “threshold exceeding metric” list and the “threshold non-exceeding metric” list. The following description is made of an example in which the record focused on in Step S1302 is the record 311. In Step S1303, the linkage determination processing determines that the “service metric threshold is not exceeded” based on the threshold of the record 411 being “200 (milliseconds/transfer)” and the performance value of the record 311 being “80 (milliseconds/transfer)”. In Step S1304, “iSCSIdiskA/IO Rate” relating to “iSCSIdiskA/Total Response Time Rate” is acquired from the service and I/O metric relationship table 234. In Step S1305, the record 321 that has the metric name 301 storing “iSCSIdiskA/IO Rate” and the time 302 being closest to the time “2014/01/01;0:00” of the record 311 is acquired from the performance information table 231.

The following description is made of an example in which the performance value 303 of the record 321 is determined to be “high in I/O metric” in Step S1306. In Step S1307, the infrastructure metric name “StorageProcessorA/Busy Rate” other than “RAIDgroupA/Busy Rate”, which relates to “iSCSIdiskA/Total Response Time Rate”, is acquired from the service and infrastructure metric relationship table 233 of FIG. 12. The following description is made of a case where the infrastructure metric name focused on in the iterative processing of Step S1308 is “StorageProcessorA/Busy Rate”. In Step S1309, the linkage determination processing acquires the record 341 from the performance information table 231. Then, in Step S1310, the record 413 is acquired from the setting threshold table 232. In Step S1311, the performance value “82(%)” of the record 341 exceeds the threshold 402 of the record 413, and hence the processing advances to Step S1312 to add the metric name “StorageProcessorA/Busy Rate” to the “threshold exceeding metric” list.

In Step S1314, the determination result of “abnormal 3” is derived from the linkage determination table 236 of FIG. 14 based on the determination results that the “infrastructure metric threshold is exceeded” in Step S906 and that the “service metric threshold is not exceeded” in Step S1303, the determination result of being “high in I/O metric” in Step S912, and the fact that the metric name “StorageProcessorA/Busy Rate” was added to the “threshold exceeding metric” list in Step S1312. From the result of Step S1314, “NO” is determined in all Steps S1315, S1317, and S1321, and “YES” is determined in Step S1325. In Step S1326, the linkage determination processing stores “1” in the variable X, and the variable Y remains “0”.

In the second embodiment, “StorageProcessorA/Busy Rate” and “RAIDgroupA/Busy Rate” are exemplified as the infrastructure metrics to exemplify infrastructures of different types. However, metrics of separate infrastructures of the same type may be employed.

The description of the second embodiment is directed to the method for handling the case where the service metric relates to a plurality of infrastructure metrics and it suffices that the service metric is linked with at least one infrastructure metric. In other words, the description is made of an evaluation method for a threshold conducted when a plurality of relating infrastructure metrics are not allowed to exceed the thresholds simultaneously with the exceeding of the threshold of a given service metric. However, a case where another relating infrastructure metric may exceed the threshold at the same timing and a case where another relating infrastructure metric is not allowed to exceed the threshold at the same timing may coexist depending on the infrastructure metric to be evaluated.

For example, a factor that delays the disk response time of the server includes deterioration in performance of one infrastructure (for example, storage processor, storage cache, or storage RAID group). Therefore, each of the utilization of the storage processor, a usage rate of the storage cache, and the utilization of the storage RAID group has correlation with the disk response time of the server.

However, when the storage processor is a bottle neck, data that has not yet been processed by the storage processor accumulates in the storage cache, and hence the exceeding of the threshold by the utilization of the storage processor and the exceeding of the threshold by the usage rate of the storage cache may occur simultaneously. Meanwhile, the data is not transmitted from the processor to the storage RAID group, and the utilization of the RAID group decreases. Hence, the exceeding of the threshold by the utilization of the storage processor and the exceeding of the threshold by the utilization of the storage RAID group are not allowed to occur simultaneously. In other words, in the evaluation of the threshold of the utilization of the storage processor, the metric of the usage rate of the storage cache is an exceptional metric.

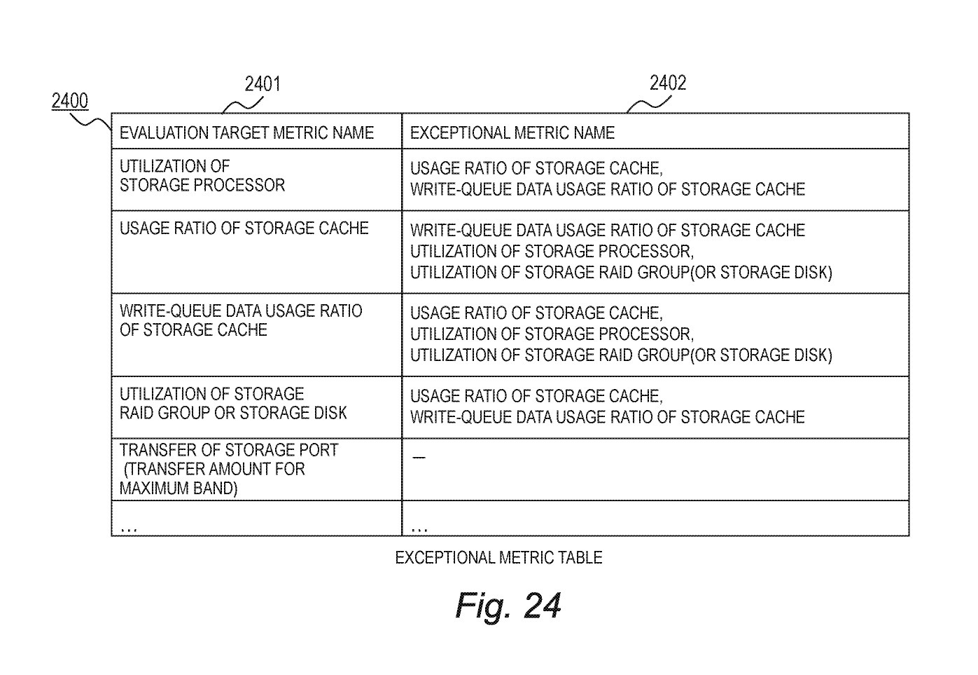

In this manner, in the evaluation of the threshold of a given infrastructure metric, when the determination as to whether or not another infrastructure metric exceeds the threshold and whether or not the evaluation value is to be reflected differ depending on the metric, such an exceptional metric table 2400 as shown in FIG. 24 may be provided.

The exceptional metric table 2400 includes a record for each performance metric, and each record includes two fields of an evaluation target metric name 2401 and an exceptional metric name 2402. The evaluation target metric name 2401 stores a value for identifying the infrastructure metric. The exceptional metric name 2402 stores identification information of an exceptional performance metric determined to be allowed to exceed the threshold simultaneously with the metric to be evaluated.

In order to handle such an exception as described above, the following processing may be conducted in the linkage determination processing according to the second embodiment.

Before the execution of Step S1314 of FIG. 13B, the exceptional metric table 2400 is referred to for the record that has the field 2401 storing the infrastructure metric name received in Step S901, and the infrastructure metric name stored in the exceptional metric name 2402 is acquired. In Step S1314, the determination result is changed to “-” when the determination result of “abnormal 1” is obtained as a result of the determination based on the linkage determination table 236 and all the infrastructure metric names stored in the “threshold exceeding metric” list correspond to the exceptional metric names 2402.

The exceptional metric table 2400 shown in FIG. 24 is a specific example of an exceptional metric table used when the infrastructure metric is evaluated by the method according to the second embodiment on the assumption that a part of the storage apparatus is an infrastructure.

Further, in the second embodiment, as described in the first embodiment, it may be determined that the service metric and the infrastructure metric are linked with each other when the performance value of the service metric does not exceed the threshold and the performance value of the infrastructure metric does not exceed the threshold. In other words, when the performance value of the service metric and the performance value of the infrastructure metric exhibit the same determination result for the respective thresholds, it can be determined that the two metrics are linked with each other. In this case, “linked” may be stored in a cell 1421 and a cell 1422 or four cells from the cell 1421 to a cell 1424 of the linkage determination table 236.

Further, as described in the first embodiment, in this case, in the determination of the presence or absence of the linkage between the service metric and the infrastructure metric, the determination that “both the performance values do not exceed the thresholds” may be given a priority lower than the determination that “both the performance values exceed the thresholds” and the determination of “abnormal”. In other words, it may be determined whether or not the determination result of Step S1314 includes a cell 1425 in Step S1315, and it may be determined whether or not the determination result of Step S1314 includes the cells from the cell 1421 to the cell 1424 when the determination of Step S1325 is false.

Further, in the second embodiment, as described in the first embodiment, the recommended threshold may be presented when the evaluation value of the threshold is low. For example, the range of the recommended threshold may be calculated by the following method, and may be presented.

A combination of the determination result obtained when “abnormal 2” or “abnormal 3” is determined based on the linkage determination table 236 in Step S1314 and the metric name 301 and the performance value 303 of the record of the set I that was focused on at a time of the determination is recorded. When the recommended threshold of a given infrastructure metric y is set to the variable X, the performance value 303 and the identification information on the cell relating to the infrastructure metric y are extracted from the recorded information. Then, the range of x is calculated based on the following simultaneous inequalities.
x<(performance value obtained when “abnormal 2” is determined)
x>(performance value obtained when “abnormal 3” is determined)

Further, as described in the first embodiment, the description of this embodiment is directed to the example in which the same threshold is set for all the service metrics having the same metric type. However, in general, different thresholds may be set for the service metrics having the same type. In the second embodiment, when it is determined by the method described in the first embodiment that the received service metric name does not have the “strictest” threshold among the metrics having the same metric type, in Step S1314, another linkage determination table obtained by changing “abnormal 3” to “-” may be used in place of the linkage determination table 236 shown in FIG. 14.

As described above, according to the second embodiment, the evaluation value of the threshold can be calculated even when the service metric relates to a plurality of infrastructure metrics and it suffices that the service metric is linked with at least one infrastructure metric. In other words, the analysis can be conducted even when the service metric and the infrastructure metric relate to each other in a one-to-many relationship, and it is possible to increase the number of patterns of the monitoring target.

Further, the threshold of the infrastructure metric is evaluated based on whether or not a plurality of infrastructure metrics exceed the thresholds (or fall below the thresholds) simultaneously. Hence, the determination as to whether or not another infrastructure metric exceeds the threshold and the evaluation value of another infrastructure metric can be reflected in the evaluation value of the infrastructure metric to be evaluated, and it is possible to calculate the evaluation values of the thresholds of a plurality of infrastructure metrics that relate to the service metric. In addition, it is possible to improve accuracy in the evaluation of the threshold.

Further, even in the case where a plurality of infrastructure metrics exceed the thresholds simultaneously, the threshold is not evaluated when the infrastructure metric name is an exceptional metric, and hence the threshold can be evaluated depending on the property of the metric with precision. Further, a relationship between special metrics can be handled. In particular, when there is no correlation between a change in the utilization of the processor of a storage apparatus and a change in a usage rate of the cache memory of the storage apparatus, the two can be handled as exceptions in the evaluation.

### Third Embodiment

Next, a third embodiment of this invention is described. Differences from the first and second embodiments are mainly described below, and descriptions of the equivalent components, the programs having the equivalent functions, and the tables having the equivalent items are omitted or simplified.

The description of the first embodiment or the second embodiment is directed to the method of evaluating the threshold of the infrastructure metric having correlation with the service metric. However, in general performance monitoring, the exceeding of the threshold is monitored even in regard to the performance metric having no correlation with the service metric.

In the third embodiment, a description is made of an evaluation method for a threshold conducted when the infrastructure metric to be evaluated has no correlation with the service metric. In the evaluation of the threshold of the infrastructure metric having no correlation with the service metric, the threshold cannot be evaluated based on the linkage with the timing at which the service metric exceeds the threshold. Therefore, the evaluation of the threshold presupposes that the threshold has been changed (or calculated) several times in the past, and is determined based on a degree of convergence of the values of the set thresholds. In short, when a standard deviation of a plurality of thresholds set in the past is small, the values converge, and hence it is determined that an appropriate threshold is almost reached.

In the third embodiment, the performance information table or the service and I/O metric relationship table is not used. The service and infrastructure metric relationship table and the threshold evaluation table that are the same as those of the first embodiment are used. The structures of the respective tables are the same as those of the first embodiment.

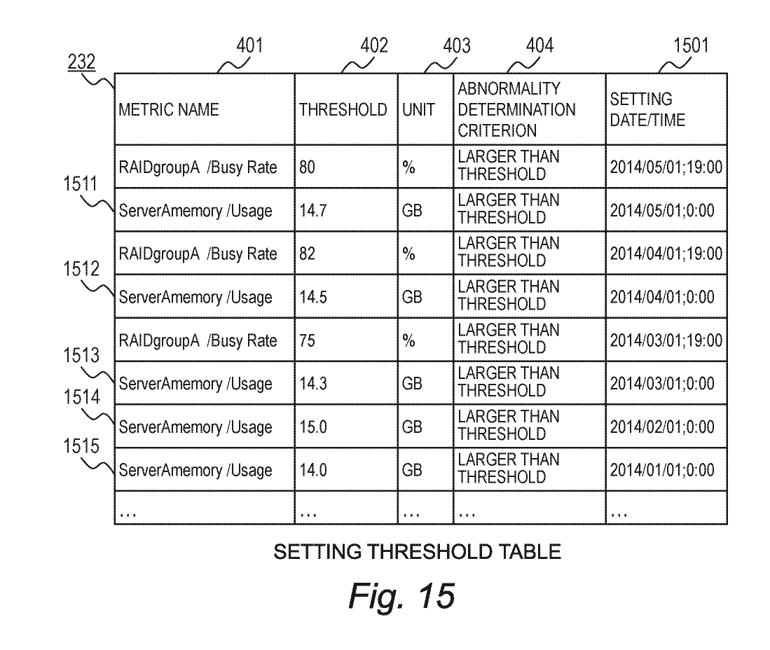

In FIG. 15, an example of a configuration of the setting threshold table 232 of the third embodiment is shown.

The structure of the setting threshold table 232 according to the third embodiment is substantially the same as the structure of the setting threshold table 232 according to the first embodiment. In order to store information on the threshold that is set (or not set but calculated by the automatic threshold setting technology), the setting threshold table 232 includes four fields of the metric name 401, the threshold 402, the unit 403, and the abnormality determination criterion 404. In addition, in order to record the information on the threshold set (calculated) in the past, the setting threshold table 232 according to the third embodiment may include a field of a setting date/time 1501 for storing the information on the date/time at which the threshold was set. Further, the setting threshold table 232 of FIG. 15 is different from the setting threshold table 232 of FIG. 4 described in the first embodiment in that there exist a plurality of records that have the metric name 401 storing the same identification information because the threshold set in the past is stored.

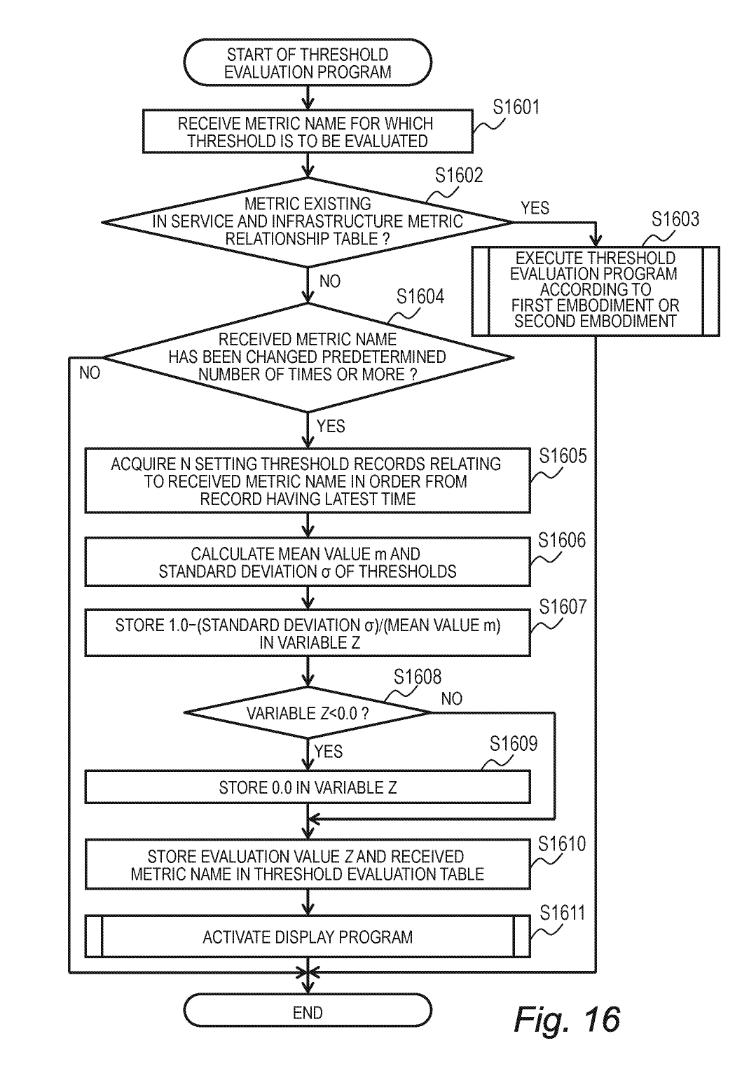

FIG. 16 is a flowchart of an example of processing conducted by the threshold evaluation program 221 according to the third embodiment. The start timing of the threshold evaluation program 221 may be the timing described in the first embodiment.

In Step S1601, the threshold evaluation program 221 receives the metric name of the infrastructure for which the threshold is to be evaluated.

In Step S1602, the threshold evaluation program 221 determines whether or not the metric name received in Step S1601 exists in the service and infrastructure metric relationship table 233. When the above-mentioned determination result is true (the received metric name exists in the service and infrastructure metric relationship table 233) (YES in S1602), the processing advances to Step S1603, and when the result of the above-mentioned determination is false (the received metric name does not exist in the service and infrastructure metric relationship table 233) (NO in S1602), the processing advances to Step S1604.

In Step S1603, the threshold evaluation program 221 executes processing of the threshold evaluation program 221 described in the first embodiment or the second embodiment with the input of the metric name received in Step S1601. In other words, the threshold evaluation program 221 executes Step S801 of the processing of the threshold evaluation program 221 exemplified in FIG. 8.

In Step S1604, the threshold evaluation program 221 refers to the setting threshold table 232 to determine whether or not there exist a predetermined number of records or more that have the metric name 401 storing the metric name received in Step S1601. In this case, the “predetermined number” may be an arbitrary integer equal to or larger than 2, which is sufficient to calculate the standard deviation of the set threshold. When the result of the above-mentioned determination is true (the received value of the metric name has been changed a predetermined number of times or more) (YES in S1604), the processing advances to Step S1605, and when the result of the above-mentioned determination is false (the number of times that the value of the received metric name has been changed is smaller than the predetermined number of times) (NO in S1604), the processing is brought to an end. When the result of the determination is false, the display program 225 may be activated to display the message that “evaluation is invalid due to insufficient data”.

In Step S1605, the threshold evaluation program 221 acquires, from the setting threshold table 232, N records that have the metric name 401 storing the metric name received in Step S1601 in order from the record that has the time 302 storing a value closest to the current time. The value “N” may be an arbitrary integer equal to or larger than 2, which is sufficient to calculate the standard deviation of the set threshold.

In Step S1606, the threshold evaluation program 221 calculates a mean value m and a standard deviation a of the values of the thresholds 402 of the records within the setting threshold table 232 acquired in Step S1605.

In Step S1607, the threshold evaluation program 221 provides a variable Z to store a value obtained by calculating “1.0−(standard deviation a)/(mean value m)” in the variable Z.

In Step S1608, the threshold evaluation program 221 determines whether or not the value of the variable Z is smaller than 0.0. When the result of the above-mentioned determination is true (the value of the variable Z is smaller than 0.0) (YES in S1608), the processing advances to Step S1609, and when the result of the above-mentioned determination is false (the value of the variable Z is equal to or larger than 0.0) (NO in S1608), the processing of advances to Step S1610.

In Step S1609, the threshold evaluation program 221 stores 0.0 in the variable Z.

In Step S1610, the threshold evaluation program 221 refers to the record that has the metric name 401 storing the metric name received from the setting threshold table 232 and the setting date/time 1501 being closest to the current time, and acquires the threshold 402 and the unit 403. Then, a record that has the metric name 701 storing the infrastructure metric name received in Step S1601, the threshold 702 storing the acquired value of the threshold 402, the unit 703 storing the acquired value of the unit 403, and the evaluation value 704 storing the variable Z is added to or updated in the threshold evaluation table 235.

In Step S1611, the threshold evaluation program 221 activates the display program 225, and the display program 225 refers to the threshold evaluation table 235 to display the evaluation result of the threshold including the evaluation value of the threshold at an arbitrary timing. The timing to display the evaluation value of the threshold may be the same timing as in the first embodiment. Further, the display program 225 may display a message that the displayed evaluation value has been calculated by a method different from the method according to the first embodiment or the second embodiment, that is, based on the degree of convergence of the set thresholds.

A specific example of the processing of FIG. 16 is as follows. For example, when the metric name “ServerAmemory/Usage” is received in Step S1601, the threshold evaluation program 221 refers to the service and infrastructure metric relationship table 233 of FIG. 5 to determine whether or not there exists a record that has the service metric name 501 or the infrastructure metric name 502 storing “ServerAmemory/Usage”. In the example shown in FIG. 5, “ServerAMemory/Usage” does not exist, and hence the processing advances to Step S1604. In Step S1604, the threshold evaluation program 221 refers to the setting threshold table 232 of FIG. 15 to determine whether or not there exist the predetermined number of records or more that have the metric name 401 storing “ServerAmemory/Usage”. For example, when “predetermined number” is four, the setting threshold table 232 of FIG. 15 includes five records having the identification information “ServerAmemory/Usage”, and hence the processing advances to Step S1605. In Step S1605, the record having “ServerAmemory/Usage” is acquired from the setting threshold table 232. For example, when N=5, records 1511 to 1515 are acquired. In Step S1606, the threshold evaluation program 221 calculates the mean value m=14.5 and the standard deviation σ≈0.34 based on the values of the thresholds 402 of the records 1511 to 1515, and stores 1.0−0.34/14.5≈0.98 in the variable Z in Step S1607. The variable Z is not smaller than 0.0, and hence the determination processing of Step S1608 advances to Step S1610.

In Step S1610, the threshold evaluation program adds, to the threshold evaluation table 235, a record that has the metric name 701 storing “ServerAmemory/Usage”, the threshold 702 storing “14.7”, the unit 703 storing “GB”, and the evaluation value 704 storing “0.98”. In Step S1611, the threshold evaluation program 221 activates the display program 225, and presents the evaluation result to the administrator. An example of the information presented to the administrator through the output device 217 by the display program 225 is shown in FIG. 11A and FIG. 11B in the same manner as in the first embodiment. The threshold evaluation result screen 1101 or the alert list screen 1102 may be presented.

As described above, according to the third embodiment, the evaluation value of the threshold can be calculated even when the infrastructure metric to be evaluated has no correlation with the service metric. Specifically, when there are a plurality of thresholds that have been set (or calculated) in the past, the standard deviation of the values is calculated, and the degree of convergence of the thresholds is obtained, to thereby be able to calculate the evaluation value of the threshold.

### Fourth Embodiment

Next, a fourth embodiment of this invention is described. Differences from the first and second embodiments are mainly described below, and descriptions of the equivalent components, the programs having the equivalent functions, and the tables having the equivalent items are omitted or simplified.

The description of the first to third embodiments is directed to the evaluation method for the threshold set for each performance metric in the performance monitoring. In the fourth embodiment, a description is made of a method applying the evaluation value of the threshold calculated by the method described in the first to third embodiments to a root cause analysis technology.

As described in the “BACKGROUND” section, in the management of the IT system, it is monitored whether or not the service and the infrastructure are operating normally, and when the status becomes abnormal, the administrator is notified of the abnormal status as an alert. The IT system is built by combining a plurality of apparatus and parts, to thereby provide the service. Therefore, the abnormal status of one part may cause the abnormal status of another part or the service being provided consecutively. In this case, the administrator is notified of a plurality of alerts, and therefore sometimes cannot identify which part has caused the failure in a short period of time.

In order to handle such a problem as described in, for example, JP 2011-518359 A, an event being the cause is detected from among a plurality of abnormal statuses detected within the IT system or signs thereof. Specifically, in JP 2011-518359 A, management software is used to convert different kinds of failures in the management target into alerts, and accumulates occurrence information on the alerts in an alert table.

Further, the management software includes an analysis engine for analyzing causal relationships between the plurality of alerts that have occurred in the management target apparatus. When an alert occurs, the analysis engine starts the analysis based on an IF-THEN rule formed of a conditional expression defined in advance and an analysis result. The rule includes a conclusion event that can be a root cause and a conditional event group caused by the conclusion event when the conclusion event occurs. Specifically, the event described in a THEN part of the rule is a conclusion event that can be the root cause, and the alert described in an IF part is a conditional event. When the conditional event group of the rule and the events indicated by the detected alert group match each other, the analysis engine displays the conclusion event described in the rule as the root cause of a plurality of failures that have occurred in the IT system.

A technology for identifying a root cause based on such an occurrence pattern of alerts can also be used in the performance monitoring. However, in the performance monitoring, an alert is generated with reference to a threshold, and hence such a root cause identification technology as described above presupposes that the threshold is set appropriately. In other words, the pattern of the alerts that can occur simultaneously is described in the rule, and hence when one infrastructure becomes the bottle neck in performance, it is necessary to simultaneously notify the alerts for services and other infrastructures to be subject to the influence. Hence, when an appropriate threshold is not set, a correct analysis result cannot be presented. Therefore, accuracy in the analysis result can be increased by also reflecting the effectiveness of the alert that has occurred in the analysis result.

In the fourth embodiment, a description is made of an example in which the evaluation value of the threshold calculated by the method described in the first to third embodiments is reflected in the analysis result derived by the root cause analysis technology.

In the fourth embodiment, the service and infrastructure metric relationship table or the service and I/O metric relationship table is not used. The performance information table, the setting threshold table, and the threshold evaluation table that are the same as those of the first embodiment are used. The structures of the respective tables are the same as those of the first embodiment.

In the fourth embodiment, the alert table 237 and the rule repository 238 of FIG. 2B are used as new data in order to describe processing for root cause analysis. Further, the root cause analysis program 222 and the alert generator program 226 are used as new programs.

<Alert Table>

The alert table 237 stores the alert information generated by the alert generator program 226. The alert generator program 226 reads the record of the performance information table 231 periodically (or when a record is added), and generates the alert information when the threshold indicated by the record of the setting threshold table 232 is exceeded to cause an abnormal status.

In this embodiment, the alert generator program 226 located within the management computer 201 generates the alert information based on the value of the performance information table 231. However, the monitoring agent within the server 202, the storage apparatus 203, and the network switch 204 of the management targets may generate the alert information based on the performance information, and the management computer 201 may receive the generated alert information and store the alert information in the alert table 237.

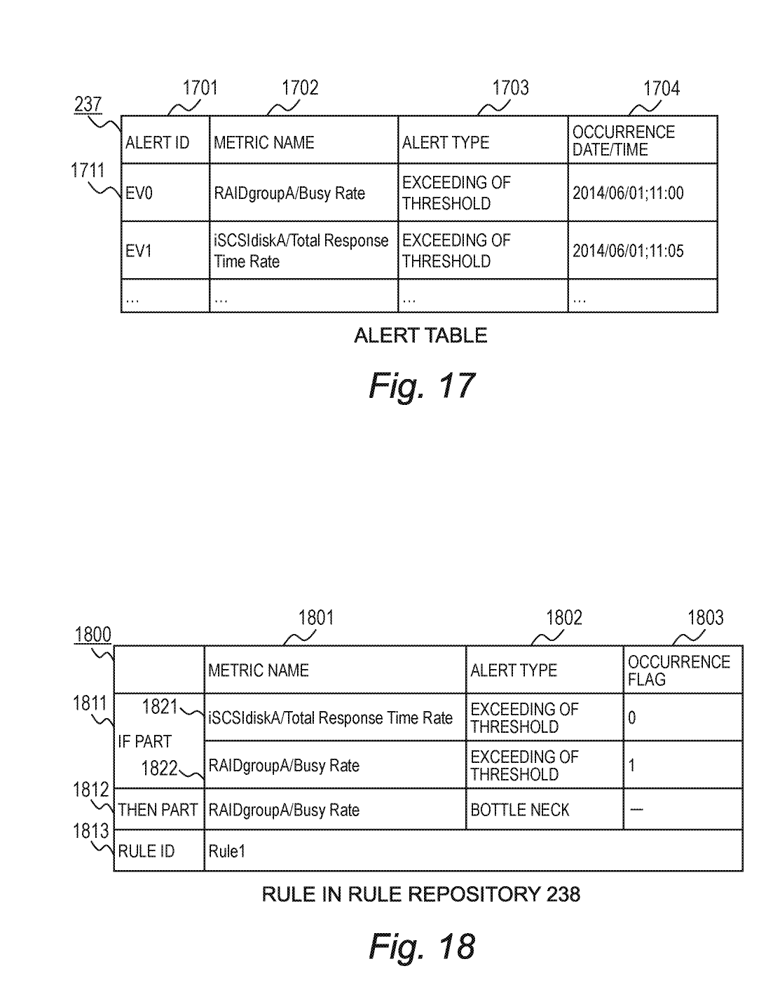

In FIG. 17, an example of a configuration of the alert table 237 is shown.

The alert table 237 includes a record for each piece of alert information, and each record includes four fields of an alert ID 1701, a metric name 1702, an alert type 1703, and an occurrence date/time 1704. The alert ID 1701 stores an identifier for uniquely identifying the alert information. The metric name 1702 stores an identifier of the performance metric that has caused the abnormal status. The alert type 1703 stores an identifier for indicating the type of the alert that has occurred in the management target. The occurrence date/time 1704 stores a time at which the alert occurred. For example, the record in the first row has the following meaning. In the metric that has the metric name indicated by “RAIDgroupA/Busy Rate”, the “exceeding of threshold” occurs at 11:00, Jun. 1, 2014.

<Rule Repository and Rule>

The rule represents information indicating a correspondence relationship between the combination of the alerts that can occur in the IT system and the event being a cause candidate of the failure to be caused when the alerts occur.

In this embodiment, the rule is described in an IF-THEN format, but may be described in another format as long as a cause event for a system failure and an alert (observed event) caused by the cause event are described.

In FIG. 18, an example of a configuration of the rule stored in the rule repository 238 is shown.

In general, the rule 1800 can be divided into two parts (fields) of a first part referred to as “IF part 1811” and a second part referred to as “THEN part 1812”. The IF part 1811 may include one or more conditional elements.

The rule 1800 indicates that the event (conclusion event) of the THEN part 1812 is the cause of the failure when the event (conditional event) of the IF part 1811 is detected. Therefore, when the status of the performance metric indicated by the THEN part 1812 becomes normal, a problem indicated by the IF part 1811 is expected to be solved.

In this embodiment, the alert information stored in the alert table 237 shown in FIG. 17 is the observed event, and cause candidates of the failure are narrowed down by the root cause analysis program 222. The IF part 1811 of the rule 1800 includes an entry for each conditional element, and each entry includes fields of a metric name 1801, an alert type 1802, and an occurrence flag 1803. In other words, the conditional element of the IF part 1811 indicates that the status indicated by the information of the alert type 1802 occurs in the performance metric specified by the metric name 1801. The occurrence flag 1803 stores a result of whether or not the alert indicated by the conditional element has been generated in actuality. When the alert indicated by the conditional element has been generated, “1” is stored in the occurrence flag 1803, and when the alert indicated by the conditional element has not been generated, “0” is stored in the occurrence flag 1803. When a predetermined time period has elapsed since “1” is stored in the occurrence flag 1803, processing for restoring “0” in the value may be conducted.

In each of the IF part 1811 and the THEN part 1812, the value stored in the metric name 1801 is the same as the value stored in the metric name 301 of the performance information table 231.

Further, the rule 1800 includes a rule ID 1813 being a field for storing a rule ID for uniquely identifying the expansion rule.

For example, the rule 1800 “Rule1” indicates that it is concluded that “the utilization of the RAID group A of the storage C is a bottle neck” when “the exceeding of the threshold of the disk response time of the iSCSI disk A of the server A (metric name=iSCSIdiskA/Total Response Time Rate)” and “the exceeding of the threshold of the utilization of a RAID group A of a storage C (metric name=RAIDgroupA/Busy Rate)” are detected as the observed alerts.

As a conditional element included in the IF part 1811, a given performance metric being normal (causing no alert) may be defined.

<Processing of Root Cause Analysis Program>

The root cause analysis program 222 identifies the root cause based on the rule 1800 and the alert information stored in the alert table 237. The root cause analysis program 222 executes processing for narrowing down root cause events based on the pattern of the alert that has occurred. In this embodiment, the root cause analysis program 222 narrows down candidates for the root cause event based on an alert information group stored in the alert table 237 and the rule stored in the rule repository 238. For example, the alert generator program 226 generates the alert information group of the alert table 237 shown in FIG. 17, and when the root cause analysis program 222 conducts analysis based on the rule 1800 shown in FIG. 18, the root cause analysis program 222 derives the conclusion that “the utilization of the RAID group A of the storage C (metric name=RAIDgroupA/Busy Rate) is a bottle neck”.

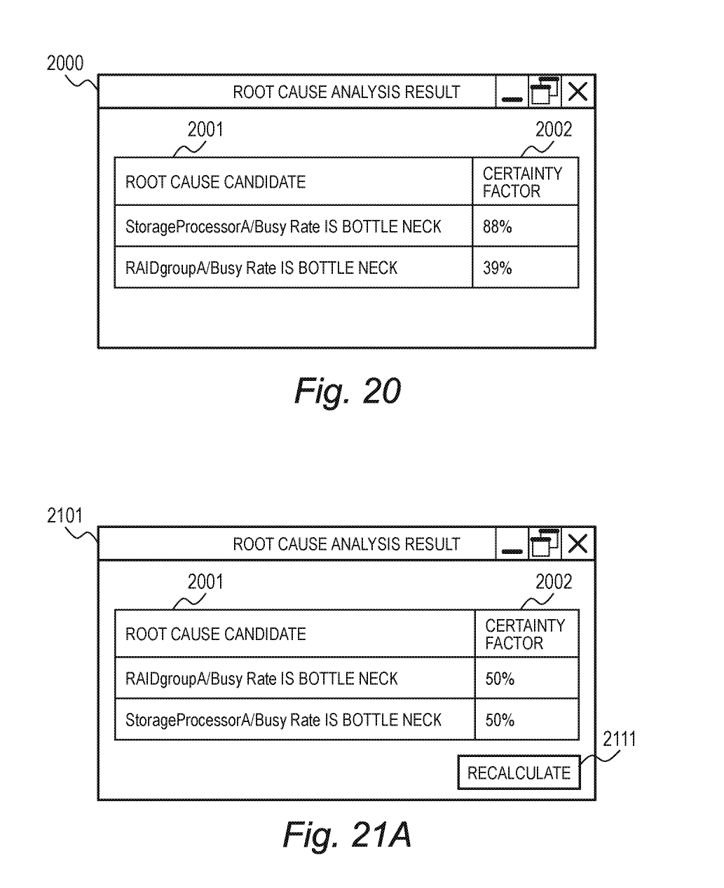

FIG. 20 is a diagram for illustrating an example of the root cause analysis result screen 2000.

The root cause analysis result screen 2000 is a screen for presenting the conclusion derived by the root cause analysis program 222 as a candidate for the root cause being the bottle neck of a plurality of failures that have occurred in the IT system. The root cause analysis result screen 2000 may include an entry for each of the root cause candidates being the bottle neck, and each entry may include a root cause candidate field 2001 for displaying the root cause candidate and a certainty factor field 2002 for displaying a likelihood (certainty factor) of the root cause candidate indicated by the field 2001. The certainty factor displayed in the certainty factor field 2002 may be an alert occurrence rate of the rule 1800 relating to the root cause candidate 2001 according to a related-art method described in JP 2011-518359 A. In the related-art method, the alert occurrence rate is calculated by the expression “(alert occurrence rate)=(number of conditional elements having the occurrence flag 1803 of “1”)/(total sum of conditional elements)×100”.

On the root cause analysis result screen 2000, a plurality of cause candidates may be sorted in descending order of the certainty factor. The certainty factor represents the likelihood of the cause candidate, and indicates that the cause candidate having a higher certainty factor is more likely to be the cause. However, when the threshold of the performance metric is not appropriate, a large number of unnecessary alerts occur, or a necessary alert does not occur. In this case, when the certainty factor is calculated only based on the alert occurrence rate, only the cause candidate having a high certainty factor is displayed, or only the cause candidate having a low certainty factor is displayed.

The root cause analysis program 222 according to this embodiment reflects the evaluation value of the threshold described in the first to third embodiments in the above-mentioned certainty factor, to thereby improve the accuracy in the analysis result of the root cause analysis.

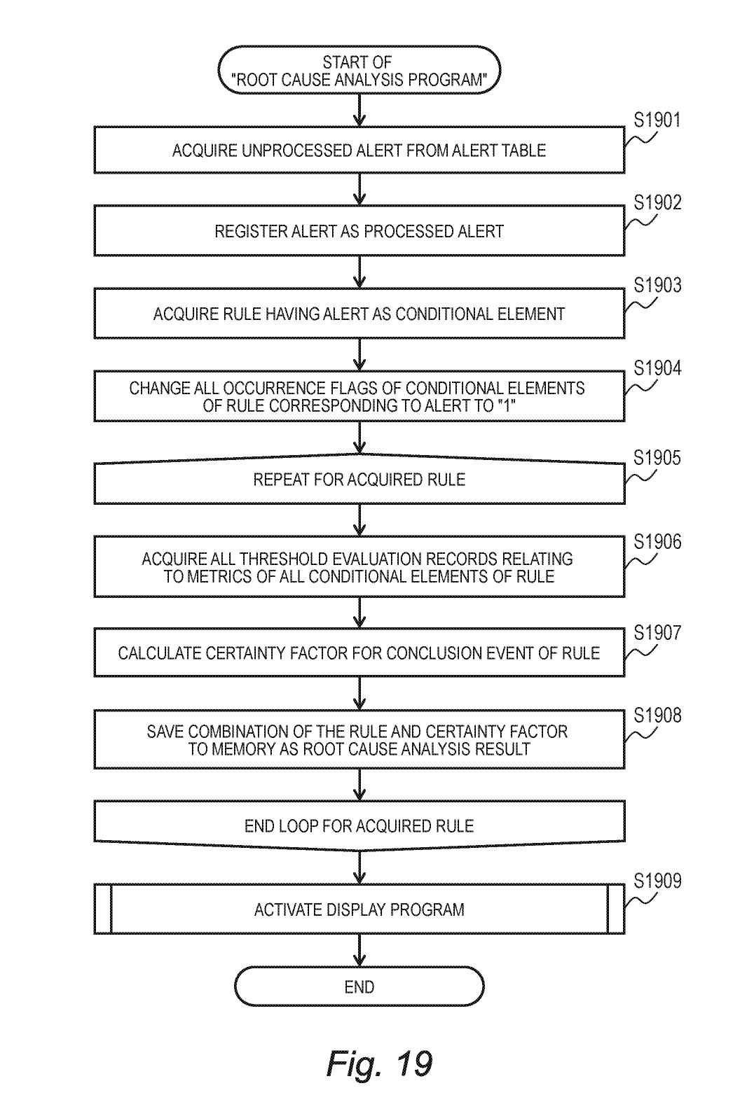

FIG. 19 is a flowchart of an example of processing executed by the root cause analysis program 222.

The root cause analysis program 222 may start the processing when an abnormal status (failure) occurs in the IT system and the alert relating to the failure is generated by the alert generator program 226. Further, the processing may be started when the administrator detects the occurrence of the failure in the IT system and the processing is activated based on the administrator's instruction issued through the input device 214.

In Step S1901, the root cause analysis program 222 acquires the alert information (record of alert table 237) that has not yet been processed by the root cause analysis program 222 from the alert table 237.

In Step S1902, the root cause analysis program 222 records the alert acquired in Step S1901 as a processed alert.

In Step S1903, the root cause analysis program 222 extracts the rule 1800 having the alert acquired in Step S1901 as the conditional element from the rule repository 238.

In Step S1904, the root cause analysis program 222 sets “1” for all the occurrence flags 1803 of the conditional elements corresponding to the alert acquired in Step S1901 among the conditional elements of the rule group acquired in Step S1903.

In Step S1905, the root cause analysis program 222 conducts the processing from Step S1906 to Step S1908 for each of the rules acquired in Step S1903.

In Step S1906, the root cause analysis program 222 acquires, from the threshold evaluation table 235, all the records that have the metric name 701 storing the identification information stored in the metric names 1801 of all the conditional elements of the rule.

In Step S1907, the root cause analysis program 222 calculates the certainty factor for the conclusion indicated by the THEN part 1812 of the rule by the following expression based on the record of the threshold evaluation table 235 acquired in Step S1906 and the occurrence flag of the conditional element of the rule.

Σ((evaluation value of the metric name of the conditional element)×(value of the occurrence flag of the conditional element)×100/Σ(evaluation value of the metric of the conditional element)
In the expression, “Σ” represents that the parenthesized calculation is conducted the number of times corresponding to the number of conditional elements included in the rule, and the results are added.

When the metric name stored in the metric name 1801 of the conditional element indicates the service metric, the “evaluation value of the metric name of the conditional element” may be 1.0 (maximum value of the evaluation value of the threshold in this embodiment).

A specific example of the calculation is described later.

In Step S1908, the root cause analysis program 222 saves a combination of the rule and the certainty factor calculated in Step S1907 to the memory as the “root cause analysis result”. When the “root cause analysis result” having the same rule is already saved to the memory, only the certainty factor may be updated.

In Step S1909, the root cause analysis program 222 activates the display program 225 to display a combination of the certainty factor and the conclusion indicated by the THEN part 1812 of the rule 1800 of the “root cause analysis result” saved to the memory in Step S1908 on the root cause analysis result screen 2000 as the analysis result.

A specific example of the processing illustrated in FIG. 19 is as follows. For example, when the record 1711 (having the metric name 1702 of “RAIDgroupA/Busy Rate” and the alert type of “exceeding of threshold”) of the alert table 237 is received in Step S1901, the root cause analysis program 222 registers the alert received in Step S1902 as “processed”. In Step S1903, the root cause analysis program 222 acquires, from the rule repository 238, the rule 1800 that has the metric name 1801 of “RAIDgroupA/Busy Rate” and the alert type 1802 of the conditional element “exceeding of threshold”. In Step S1904, as shown in FIG. 18, the root cause analysis program 222 changes the occurrence flag 1803 of the conditional element 1822 having the metric name and the alert type that are the same as those of the received record 1711 to “1”.

The following description is directed to an exemplary case where the rule of interest is the rule 1800 of FIG. 18 in the iterative processing of Step S1905. In Step S1906, the root cause analysis program 222 refers to the threshold evaluation table 235 to search for the record that has the metric name 701 storing the metric names “RAIDgroupA/Busy Rate” and “iSCSIdiskA/Total Response Time Rate” included in the rule 1800. In the example shown in FIG. 7, only the record 711 is applicable, and hence the record 711 is acquired. In Step S1907, the root cause analysis program 222 calculates the certainty factor of the rule 1800 based on the record 711 and the rule 1800. The evaluation value of the metric “RAIDgroupA/Busy Rate” is 0.65 from the record 711, and the metric “iSCSIdiskA/Total Response Time Rate” is the service metric, to thereby set the evaluation value to 1.0. When the rule 1800 is focused on, only “RAIDgroupA/Busy Rate” has the occurrence flag 1803 of “1”. Therefore, the certainty factor is calculated by the following expression.

(Certainty factor)=(0.65×1+1.0×0)×100/(0.65+1.0)≈39

In Step S1908, the root cause analysis program 222 saves a combination of the rule 1800 and the certainty factor “39(%)” to the memory. In Step S1909, the root cause analysis program 222 activates the display program 225 to present the root cause analysis result to the administrator.

When there exist a plurality of rules having the same conclusion (that is, having the same value stored in the metric name 1801 and the alert type 1802 of the THEN part 1812), a maximum value or a mean value of the calculated certainty factors may be displayed as the value of the certainty factor 2002 to be displayed in association with the root cause candidate 2001 on the root cause analysis result screen 2000.

As described above, according to the fourth embodiment, the evaluation value of the threshold calculated by the method described in the first to third embodiments can be reflected in the analysis result of the root cause analysis technology. As a result, it is possible to increase the accuracy in the analysis result.

### Fifth Embodiment

Next, a fifth embodiment of this invention is described. Differences from the first embodiment and the second embodiment are mainly described below, and descriptions of the equivalent components, the programs having the equivalent functions, and the tables having the equivalent items are omitted or simplified.

In the fourth embodiment, the description is made of the method of reflecting the evaluation value of the threshold, which is calculated by the method described in the first to third embodiments, in the analysis result of the root cause analysis technology. In the fifth embodiment, a description is made of a method of reflecting the evaluation value of the threshold in the analysis result by another method.

In the method of the fourth embodiment, a method of calculating the certainty factor according to the related-art root cause analysis technology is changed, and the evaluation value of the threshold is reflected in the certainty factor, to thereby increase the accuracy in the analysis result. This is a method of increasing the accuracy in the analysis result by adding the evaluation of an alert itself in order to handle the situation in which an unnecessary alert occurs or a necessary alert fails to occur when the set threshold is not appropriate. Meanwhile, when the set threshold is appropriate, a sufficiently correct analysis result can be derived by the related-art root cause analysis technology.

In the above-mentioned circumstances, in the fifth embodiment, a description is made of a method of again conducting the analysis with a changed threshold only when the administrator examines the analysis result after the analysis result is presented to the administrator by the method of the related-art root cause analysis technology and determines that the cause cannot be identified. The threshold may be changed based on the evaluation value. Further, in the fifth embodiment, the threshold is evaluated based on the method according to the first embodiment or the second embodiment.

In the description of the fifth embodiment, the service and infrastructure metric relationship table or the service and I/O metric relationship table is not used. The performance information table, the setting threshold table, and the threshold evaluation table that are the same as those of the first embodiment are used. Further, the alert table and the rule repository that are the same as those of the fourth embodiment are used. The structures of the respective tables and repositories are the same as those of the first embodiment or the fourth embodiment.

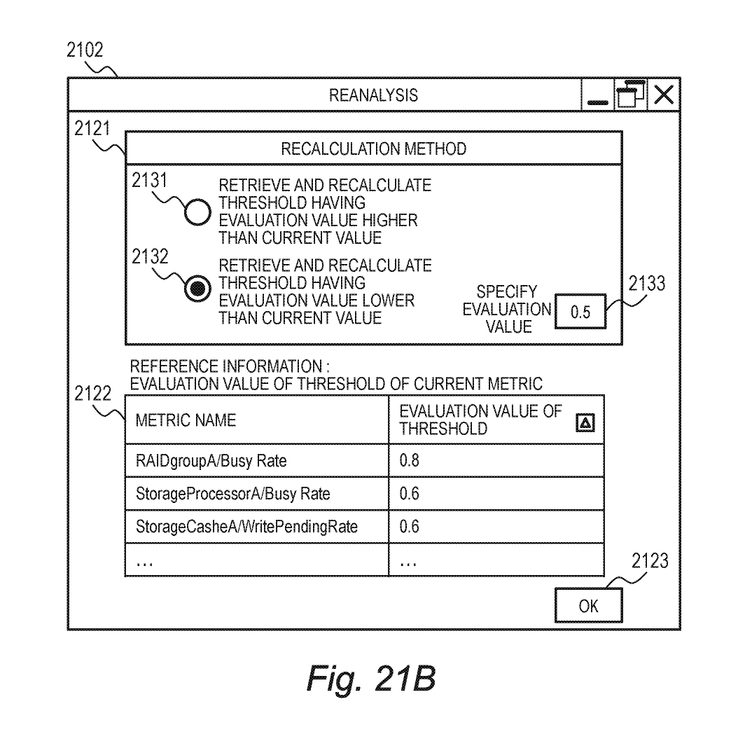

In FIG. 21A and FIG. 21B, examples of screens displayed according to the fifth embodiment are shown.

In FIG. 21A, an example of a root cause analysis result screen 2101 for displaying the analysis result derived by the related-art root cause analysis technology is shown. The root cause analysis result screen 2101 is substantially the same structure as the structure of the root cause analysis result screen 2000 according to the fourth embodiment. In the same manner as in the fourth embodiment, the root cause analysis result screen 2101 includes an entry for each root cause candidate to be a bottle neck, and each entry includes the root cause candidate field 2001 for displaying the root cause candidate and the certainty factor field 2002 for displaying the likelihood (certainty factor) of the root cause candidate indicated by the field 2001. In contrast, the root cause analysis result screen 2101 according to the fifth embodiment includes a recalculate button 2111 in order to allow the analysis to be carried out again with a changed threshold when the administrator determines that the root cause cannot be identified.

In FIG. 21B, an example of a reanalysis screen 2102 to be displayed when the recalculate button 2111 is operated, which allows the administrator to specify a recalculation method for the analysis, is shown. The reanalysis screen 2102 includes a recalculation method field 2121 for determining a method of changing the threshold and an OK button 2123 to be operated at start of a reanalysis in order to start the reanalysis based on the information specified by the recalculation method field 2121. The reanalysis screen 2102 may further include a field 2122 for displaying the evaluation value of the set threshold of each metric as reference information. In the field 2122, a pair of the metric name and the evaluation value of the threshold may be displayed for each metric.

The recalculation method field 2121 may be formed of two radio buttons in order to allow selection from two options. A radio button 2131 is selected to retrieve and reanalyze the threshold to exhibit an evaluation value as high as possible above the threshold set for each metric. A radio button 2132 is selected to retrieve and reanalyze the threshold to exhibit an evaluation value lower than the threshold set for each metric. In addition, a text box 2133 for specifying a value to which the evaluation value of the threshold is to be lowered may be configured to become active when the radio button 2132 is selected. The administrator can determine the value to be input to the text box 2133 with reference to, for example, the evaluation value of the threshold of each metric displayed in the field 2122.

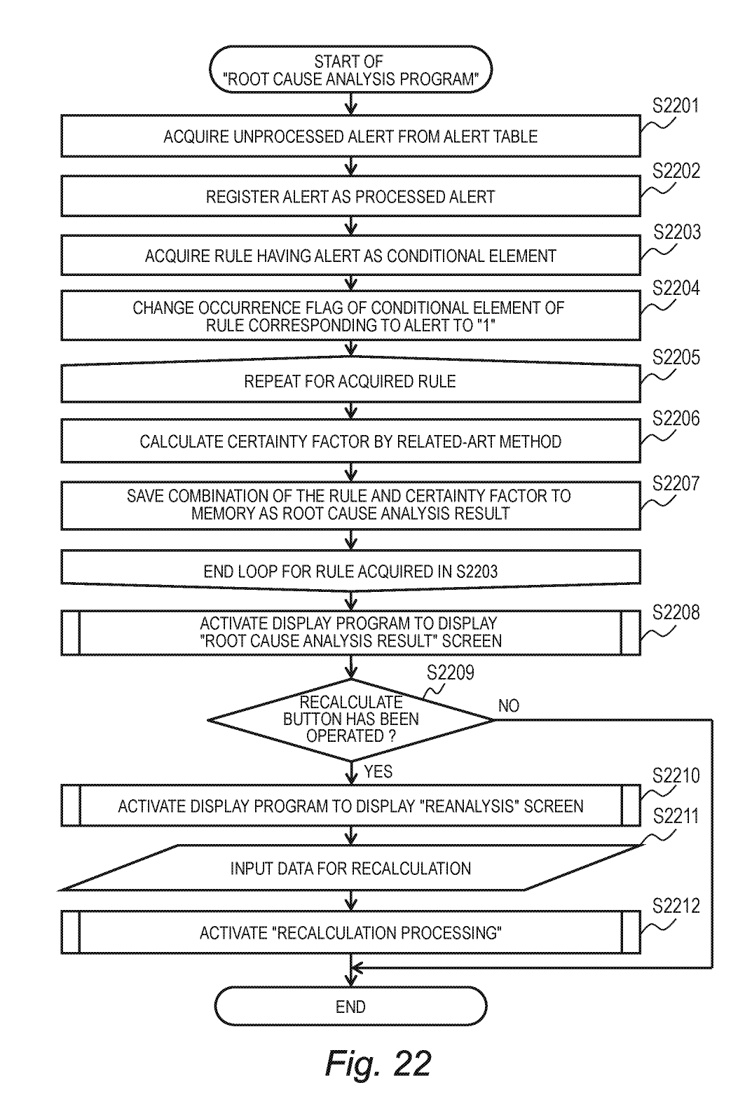

FIG. 22 is a flowchart of an example of processing conducted by the root cause analysis program 222 according to the fifth embodiment. A timing to start the root cause analysis program 222 may be the timing to start the root cause analysis program 222 according to the fourth embodiment.

The processing from Step S2201 to Step S2204 is the same as the processing from Step S1901 to Step S1904 according to the fourth embodiment, and hence a description thereof is omitted.

In Step S2205, the root cause analysis program 222 conducts the processing from Step S2206 to Step S2207 for each of the rules acquired in Step S2203.

In Step S2206, the root cause analysis program 222 calculates the certainty factor for the conclusion indicated by the THEN part 1812 of the rule by the following expression based on the occurrence flag of the conditional element of the rule.

Σ(value of the occurrence flag of the conditional element)×100/(number of conditional elements included in the rule)
In the expression, “93 ” represents that the parenthesized calculation is conducted the number of times corresponding to the number of conditional elements included in the rule, and the results are added.

In Step S2207, the root cause analysis program 222 saves a combination of the rule and the certainty factor calculated in Step S2206 to the memory as the “root cause analysis result”. When the “root cause analysis result” having the same rule has already been saved to the memory, only the certainty factor may be updated.

In Step S2208, the root cause analysis program 222 activates the display program 225 to display a combination of the certainty factor and the conclusion indicated by the THEN part 1812 of the rule 1800 within the “root cause analysis result” saved to the memory in Step S2207 on the root cause analysis result screen 2101 as the analysis result.

In Step S2209, the root cause analysis program 222 determines whether or not the user (administrator) has operated the recalculate button 2111 on the root cause analysis result screen 2101 to instruct the reanalysis of the root cause candidate. When the result of the above-mentioned determination is true (the recalculate button 2111 has been operated) (YES in S2209), the processing advances to Step S2210, and when the result of the above-mentioned determination is false (the recalculate button 2111 has not been operated) (NO in S2209), the processing is brought to an end.

In Step S2210, the root cause analysis program 222 activates the display program 225 to display the reanalysis screen 2102.

In Step S2211, the root cause analysis program 222 receives data input through the reanalysis screen 2102 by the administrator. In this embodiment, the “input data” represents identification information on the radio button 2131 or the radio button 2132 selected on the reanalysis screen 2102 and information on the text box 2133 input when the radio button 2132 is selected.

In Step S2212, the root cause analysis program 222 activates “recalculation processing” with the input of the data received in Step S2211.

A specific example of the processing of FIG. 22 is as follows. For example, when the record 1711 (having the metric name 1702 of “RAIDgroupA/Busy Rate” and the alert type of “exceeding of threshold”) of the alert table 237 is received in Step S2201, the root cause analysis program 222 registers the alert received in Step S2202 as “processed”. In Step S2203, the root cause analysis program 222 acquires, from the rule repository 238, the rule 1800 that has the metric name 1801 of “RAIDgroupA/Busy Rate” and the alert type 1802 of the conditional element “exceeding of threshold”. In Step S2204, the root cause analysis program 222 changes the occurrence flag 1803 of the conditional element 1822 having the metric name and the alert type that are the same as those of the received record 1711 to “1” as shown in FIG. 18.

The following description is directed to an exemplary case where the rule of interest is the rule 1800 of FIG. 18 in the iterative processing of Step S2205. In Step S2206, the root cause analysis program 222 calculates the certainty factor of the rule 1800 based on the rule 1800. When the rule 1800 is focused on, only “RAIDgroupA/Busy Rate” has two conditional elements in the rule 1800 and has the occurrence flag 1803 of “1”. Therefore, the certainty factor is calculated by the following expression.

(Certainty factor)=(0+1)×100/ 2≈50

In Step S2207, the root cause analysis program 222 saves a combination of the rule 1800 and the certainty factor “50(%)” to the memory. In Step S2208, the root cause analysis program 222 activates the display program 225 to display the root cause analysis result on the root cause analysis result screen 2101. When the recalculate button 2111 is operated on the root cause analysis result screen 2101, the root cause analysis program 222 advances the processing to Step S2210 to display the reanalysis screen 2102. When the data input through the reanalysis screen 2102 is received in Step S2211, the “recalculation processing” is activated in Step S2212.

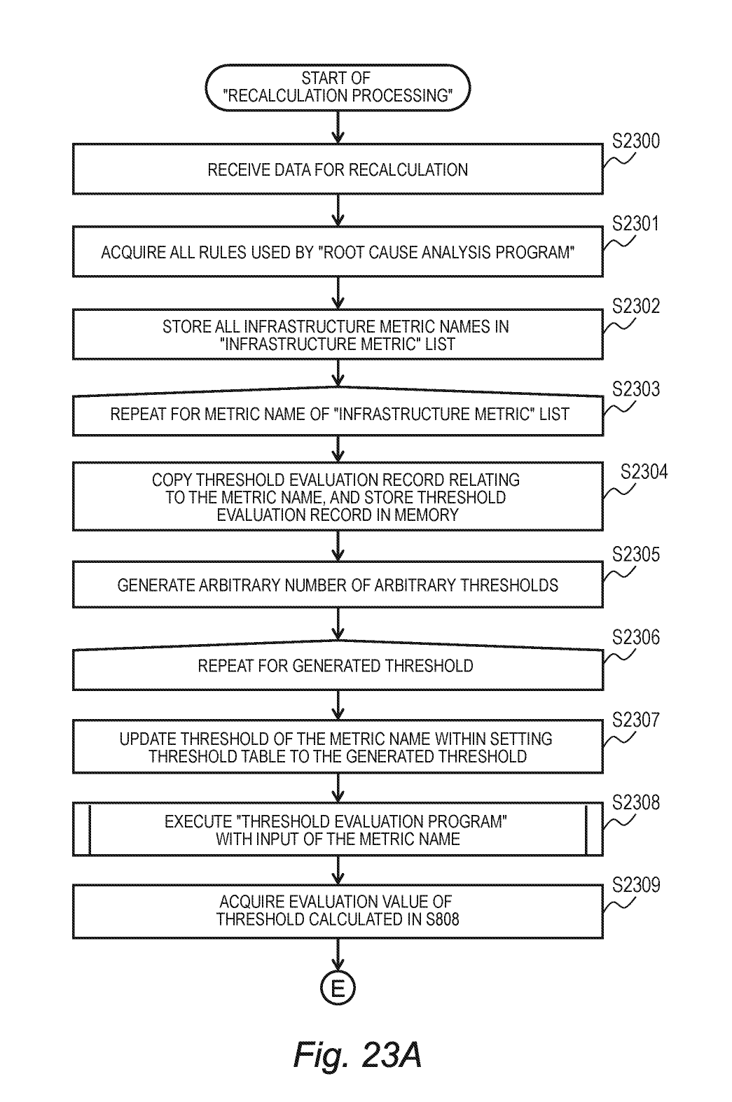

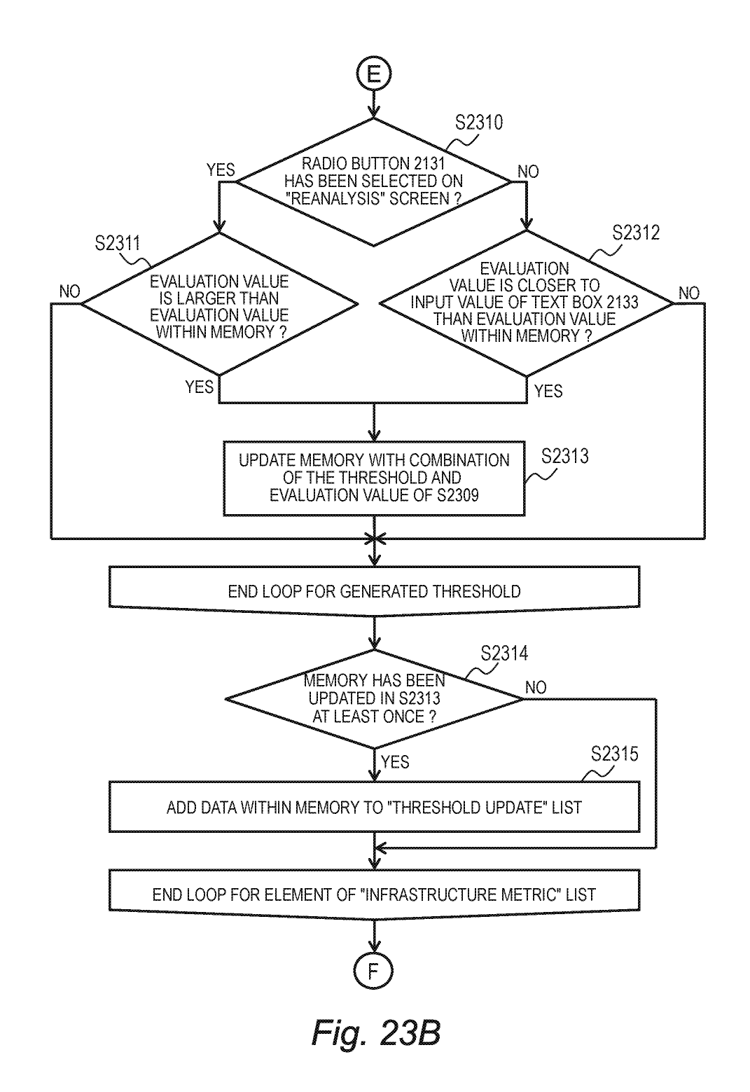

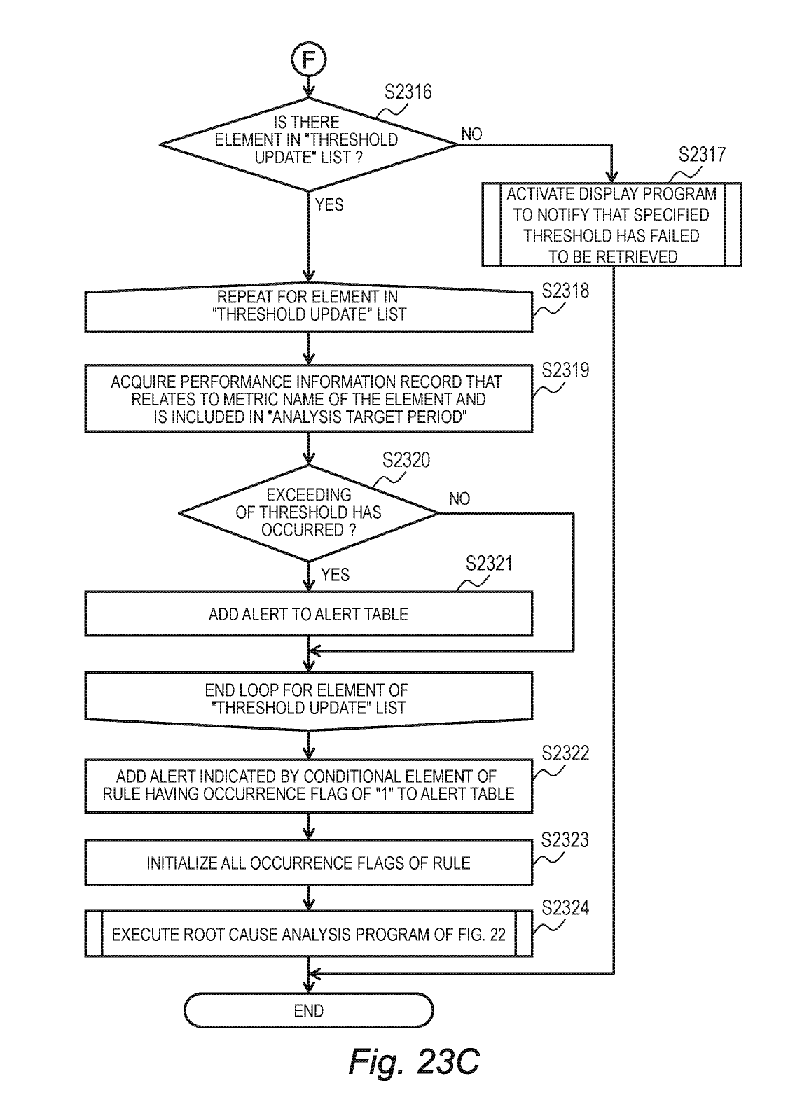

FIG. 23A, FIG. 23B, and FIG. 23C are detailed flowcharts of the “recalculation processing” executed in Step S2212 by the root cause analysis program 222 according to the fifth embodiment.

In the “recalculation processing”, the threshold set for each performance metric is temporarily changed based on the data input through the reanalysis screen 2102, and analysis processing for the root cause identification is executed again.

In Step S2300, the recalculation processing receives the data input through the reanalysis screen 2102 (identification information on the selected radio button and value input to the text box 2133).

In Step S2301, the recalculation processing acquires all the rules used by the root cause analysis program 222 of FIG. 22. In other words, all the rules 1800 saved to the memory in Step S2207 are acquired.

In Step S2302, the recalculation processing acquires all the infrastructure metric names managed by the management computer 201, and stores the infrastructure metric names in the “infrastructure metric” list.

In Step S2303, the recalculation processing conducts the processing from Step S2304 to Step S2315 for each of the metric names stored in the “infrastructure metric” list.

In Step S2304, the recalculation processing copies the record that has the metric name 701 storing the metric name from the threshold evaluation table 235, and stores the record in the memory. When the threshold evaluation table 235 has no applicable record, the processing may keep executing the iterative processing from Step S2303 instead of advancing to Step S2305.

In Step S2305, the recalculation processing generates an “arbitrary number” of “thresholds having an arbitrary value” for the performance value of the performance metric indicated by the metric name. For example, the performance value of the metric within a predetermined period before and after the occurrence of the failure may be acquired from the performance information table 231, all times at which the inclination of a performance graph created by the performance value becomes 0 (that is, point of change at which the performance value starts to fall after rising and point of change at which the performance value starts to rise after falling) may be calculated, and the performance values at the above-mentioned times may be derived as the “threshold having an arbitrary value”. In another case, the performance values of the metric corresponding to an arbitrary period may be acquired from the performance information table 231, and values extracted at random from among the values equal to or smaller than the maximum value of the performance value and equal to or larger than the minimum value may be derived as the “thresholds having an arbitrary value”. The “arbitrary number” may be determined at random, or may be determined based on a processing amount of the recalculation processing in order to reduce the processing amount.

In Step S2306, the recalculation processing conducts the processing from Step S2307 to Step S2313 for each of the thresholds generated in Step S2305.

In Step S2307, the recalculation processing retrieves the record that has the metric name 401 storing the metric name from the setting threshold table 232, and updates the value of the threshold 402 to the generated threshold.

In Step S2308, the recalculation processing executes the threshold evaluation program 221 according to the first embodiment or the second embodiment with the input of the metric name. In other words, the threshold evaluation program 221 is executed based on the setting threshold table 232 updated in Step S2307. However, Step S809 for displaying the evaluation result of the threshold does not need to be executed.

In Step S2309, the recalculation processing acquires the evaluation value of the threshold calculated in Step S808 of the threshold evaluation program 221 executed in Step S2308.

In Step S2310, the recalculation processing determines whether or not the radio button 2131 has been selected on the reanalysis screen 2102 based on data for recalculation received in Step S2300. When the result of the above-mentioned determination is true (the radio button 2131 has been selected) (YES in S2310), the processing advances to Step S2311, and when the result of the above-mentioned determination is false (the radio button 2131 has not been selected) (NO in S2310), the processing advances to Step S2312.

In Step S2311, the recalculation processing determines whether or not the evaluation value acquired in Step S2309 is larger than the evaluation value stored in the memory. When the result of the above-mentioned determination is true (the acquired evaluation value is larger than the evaluation value stored in the memory) (YES in S2311), the processing advances to Step S2313, and when the result of the above-mentioned determination is false (the acquired evaluation value is equal to or smaller than the evaluation value stored in the memory) (NO in S2311), the processing keeps executing the iterative processing from Step S2306.

In Step S2312, the recalculation processing determines based on the data for the recalculation received in Step S2300 whether or not the evaluation value acquired in Step S2309 is closer to the value input to the text box 2133 than the evaluation value stored in the memory. When the result of the above-mentioned determination is true (the acquired evaluation value is closer to the value input to the text box than the evaluation value stored in the memory) (YES in S2312), the processing advances to Step S2313, and when the result of the above-mentioned determination is false (the acquired evaluation value is closer to the evaluation value stored in the memory than the value input to the text box) (NO in S2312), the processing keeps executing the iterative processing from Step S2306.

In Step S2313, the recalculation processing updates the evaluation value 704 of the record stored in the memory with the evaluation value acquired in Step S2309, and updates the value of the threshold 702 to the value of the generated threshold.

In Step S2314, the recalculation processing determines whether or not the memory has been updated in Step S2313 within the iterative processing of Step S2306 at least once. When the result of the above-mentioned determination is true (memory has been updated in Step S2313) (YES in S2314), the processing advances to Step S2315, and when the result of the above-mentioned determination is false (the memory has never been updated in Step S2313) (NO in S2312), the processing keeps executing the iterative processing of Step S2303.

In Step S2315, the recalculation processing adds the record stored in the memory to a “threshold update” list.

In Step S2316, the recalculation processing determines whether or not there is an element in the “threshold update” list. When the result of the above-mentioned determination is true (there is an element in the “threshold update” list) (YES in S2316), the processing advances to Step S2318, and when the result of the above-mentioned determination is false (there is no element in the “threshold update” list) (NO in S2316), the processing advances to Step S2317.

In Step S2317, the recalculation processing activates the display program 225 to notify that the threshold of the specified evaluation value has failed to be retrieved.

In Step S2318, the recalculation processing conducts the processing from Step S2319 to Step S2322 for each of the elements of the “threshold update” list.

In Step S2319, the recalculation processing acquires, from the performance information table 231, the record that has the metric name 301 storing the metric name of the element and is included in an analysis target period of the root cause analysis program 222. The analysis target period of the root cause analysis program 222 may be, for example, a period indicated by the maximum value and the minimum value of the occurrence date/time 1704 of the record within the alert table acquired in Step S2201.

In Step S2320, the recalculation processing compares the respective performance values 303 of a record group of the performance information table 231 acquired in Step S2319 with the thresholds 702 included in the elements, and determines whether or not there is at least one of the performance values 303 that exceeds the threshold. When the result of the above-mentioned determination is true (at least one of the performance values exceeds the threshold) (YES in S2320), the processing advances to Step S2321, and when the result of the above-mentioned determination is false (none of the performance values exceeds the threshold) (NO in S2320), the processing keeps executing the iterative processing of Step S2318.

In Step S2321, the recalculation processing adds, to the alert table 237, a record that has the alert ID 1701 storing an arbitrary identifier, the metric name 1702 storing the metric name 701 of the element, the alert type 1703 storing “exceeding of threshold”, and the occurrence date/time 1704 storing the current date/time.

In Step S2322, a conditional element having the occurrence flag 1803 of “1” and having the metric name 1801 that is not included in the element of the “threshold update” list is extracted from among the conditional elements of the rule group acquired in Step S2301, and the alert for the exceeding of the threshold of the metric name 1801 is added to the alert table 237. In other words, a record that has the alert ID 1701 storing an arbitrary identifier, the metric name 1702 storing the metric name 1801 of the extracted conditional element, the alert type 1703 storing “exceeding of threshold”, and the occurrence date/time 1704 storing the current time is added.

In Step S2323, the recalculation processing initializes all the occurrence flags 1803 of the conditional elements of the rule group acquired in Step S2301 (sets the values to zero).

In Step S2324, the recalculation processing executes the root cause analysis program illustrated in FIG. 22. In other words, the reanalysis is executed based on the updated alert table.

It should be noted that, when the recalculation processing is finished, the record of the setting threshold table 232 updated in Step S2307 and the record of the threshold evaluation table 235 updated in Step S808 of the threshold evaluation program 221 executed in Step S2308 may be returned to the values before the update. Further, when the recalculation processing is finished, the records of the alert table added in Step S2321 and Step S2322 may be deleted.

Further, when a plurality of thresholds having different values and the same evaluation values are generated in the iterative processing of Step S2306, root cause analyses may be carried out for cases where the respective thresholds are set, and a plurality of root cause analysis results may be presented to the administrator.

When the administrator selects the radio button 2131 on the reanalysis screen 2102 and a threshold having an evaluation value higher than the related-art evaluation value is found in Step S2311, the found threshold may be presented to the administrator as the recommended threshold.

A specific example of the processing of FIG. 23A, FIG. 23B, and FIG. 23C is as follows. For example, a case where the “identification information on the radio button 2131” is received as the data for the recalculation in Step S2300 and the rule 1800 shown in FIG. 18 is acquired in Step S2301 is taken as an example. In Step S2302, the recalculation processing extracts the infrastructure metric names “RAIDgroupA/Busy Rate”, “StorageProcessorA/Busy Rate”, and the like managed by the management computer 201, and stores the infrastructure metric names in the “infrastructure metric” list. The following description is directed to an exemplary case where the metric name “RAIDgroupA/Busy Rate” obtained in the iterative processing of Step S2303 is focused on. In Step S2304, the record 711 having the metric name “RAIDgroupA/Busy Rate” is copied from the threshold evaluation table 235, and is stored in the memory.

The following description is directed to an exemplary case where one threshold “90(%)” is generated in Step S2305. In this case, in Step S2307, the threshold 402 of the record 412 of the setting threshold table 232 is updated to “90”. The following description is made of an exemplary case where “0.70” is acquired as the evaluation value in Step S2309 as a result of executing the threshold evaluation program in Step S2308. Having received the “identification information on the radio button 2131” in Step S2300, in Step S2310, the recalculation processing advances the processing to Step S2311. Further, the value of the evaluation value 704 of the record 412 copied to the memory in Step S2304 is “0.65”, and the evaluation value “0.70” has been acquired in Step S2309, and hence in Step S2311, the processing advances to Step S2313. Then, in Step S2313, the threshold 702 of the record 412 copied to the memory is updated to “90”, and the evaluation value 704 is updated to “0.70”. In Step S2314, the memory has been updated, and hence the processing advances to Step S2315. In Step S2315, the following record is added to the “threshold update” list.

Record A of the threshold evaluation table 235, which has the metric name 701 storing “RAIDgroupA/Busy Rate”, the threshold 702 storing “90”, the unit 703 storing “%”, and the evaluation value 704 storing “0.70”

In Step S2316, there is an element in the “threshold update” list, and hence the processing advances to Step S2318.

The following description is made of an exemplary case where Record A described above is focused on in the iterative processing of Step S2318 and the analysis target period of the root cause analysis program ranges from “0:00, Jan. 1, 2014” to “0:10, Jan. 1, 2014”. In Step S2319, the recalculation processing acquires the records 331 and 332 from the performance information table. In Step S2320, it is determined that the exceeding of the threshold has not occurred because the performance values of the records 331 and 332 are “82” and “85”, respectively, and the threshold 702 of Record A of interest is “90”. Therefore, the processing advances to Step S2322. In Step S2322, the conditional element having the occurrence flag of “1” within the rule 1800 is only the entry 1822 with “RAIDgroupA/Busy Rate” being stored in the “threshold update” list, and hence the processing advances to Step S2323 without conducting any particular processing. In Step S2323, all the occurrence flags 1803 of the rule 1800 are updated to “0”, and in Step S2324, the root cause analysis program 222 is executed. No alerts have been added to the alert table in Step S2321 and S2322, and hence the occurrence flags 1803 of the rule 1800 remain “0” as a result of executing the root cause analysis program 222 with the certainty factor being “0” as well. Therefore, on the root cause analysis result screen 2101, the certainty factor 2002 of the root cause candidate “RAIDgroupA/Busy Rate is bottle neck” is changed to “0%”.

This embodiment is described by taking the example of displaying the reanalysis screen 2102 to allow the administrator to determine whether or not to conduct the reanalysis. However, the root cause analysis program 222 may automatically determine whether or not to conduct the reanalysis based on the value of the certainty factor displayed on the root cause analysis result screen 2101. For example, it may be determined that the reanalysis is to be conducted when there are a plurality of root cause candidates exhibiting the certainty factor having the largest value.

As described above, according to the fifth embodiment, the evaluation value of the threshold calculated by the method described in the first embodiment and the second embodiment can be reflected in the analysis result of the root cause analysis technology by a method different from that of the fourth embodiment. Specifically, after the analysis result is presented to the administrator by the method of the relatedart root cause analysis technology in consideration of the possibility that the set threshold is appropriate as well, when the administrator examines the analysis result and determines that the cause cannot be identified, the threshold is changed based on the evaluation value, and the analysis is conducted again. Therefore, it is possible to improve the accuracy in the root cause analysis.

It is possible to further improve the accuracy in the root cause analysis by using the threshold having the evaluation value higher than the related-art evaluation value in the reanalysis.

Further, it is possible to flexibly analyze the root cause with reference to the evaluation value of the threshold of each metric by using the threshold having the evaluation value lower than the related-art evaluation value in the reanalysis.

In the first embodiment to the fifth embodiment described above, the threshold of each performance metric is evaluated based on the relationships between the iSCSI disk of the server and the parts forming the storage apparatus. The method described in each environment may be applied not only to the relationship between the server and the storage apparatus but also to, for example, a relationship between a web server (or application server) and a database server or the like. In other words, a response time for coupling to the web server may be set as the service metric, and a CPU usage rate of the database server may be set as the infrastructure metric.

Further, in the first embodiment to the fifth embodiment described above, a fixed threshold (hard threshold) is used as an example of the threshold to be evaluated, but this invention may be applied to the evaluation of a dynamic threshold calculated based on a baseline derived based on the past performance value.

What is claimed is:

1. A management computer configured to monitor a system including an apparatus, the management computer comprising:
a storage unit;
a processor configured to refer to the storage unit; and
an interface for communications to/from the apparatus, wherein:
the storage unit is configured to hold:
performance information including a performance value of the apparatus and a performance value of a service provided by the system;
setting threshold information including a threshold which is used for determining whether or not each of the performance values is abnormal; and
service infrastructure performance relationship information including a pair of a service performance name and an apparatus performance name that exhibit correlation in change of performance; and
the processor is configured to:
select, in the case of receiving a first apparatus performance name for identifying the performance of the apparatus, the service performance name that forms a pair with the received first apparatus performance name from the service infrastructure performance relationship information;
select the performance value of the received first apparatus performance name and the performance value of the selected service performance name from the performance information;
select the threshold of the first apparatus performance name and the threshold of the selected service performance name from the setting threshold information;
determine whether or not the performance value of the first apparatus performance name exceeds the threshold of the first apparatus performance name within a predetermined period;
determine whether or not the performance value of the service performance name exceeds the threshold of the service performance name within the predetermined period;
evaluate the threshold of the first apparatus performance name so as to increase evaluation of the threshold when a determination result of the performance value of the first apparatus performance name and a determination result of the performance value of the service performance name are the same result simultaneously; and
output an evaluation result of the threshold.

2. The management computer according to claim 1, wherein:
the storage unit is configured to hold service and I/O relationship information including a pair of the service performance name and an I/O performance name indicating an input/output amount of data of the apparatus, which exhibit correlation in change of performance; and
the processor is configured to:
select the I/O performance name that forms a pair with the selected service performance name from the service and I/O relationship information;
select, from the performance information, the performance value of the selected I/O performance name at a time close to a time indicated by the performance value of the selected service performance name;
determine whether or not the performance value of the I/O performance name within the predetermined period is high; and
evaluate the threshold of the first apparatus performance name based on the determination result of the performance value of the first apparatus performance name, the determination result of the performance value of the service performance name, and a determination result of the performance value of the I/O performance name.

3. The management computer according to claim 2, wherein the processor is configured to:
select all the performance values of the selected I/O performance name from the performance information; and
deteimine that the performance value of the I/O performance name within the predetermined period is high in the case where the performance value of the I/O performance name within the predetermined period is included in a predetermined proportion from a top of all the performance values of the selected I/O performance name.

4. The management computer according to claim 2, wherein the processor is configured to:
identify a plurality of times at which the performance value of the selected service performance name exceeds the threshold;
select the performance values of the I/O performance name at a plurality of times close to the identified plurality of times from the performance information; and
deteimine that the performance value of the I/O performance name within the predetermined period is high in the case where the performance value of the I/O performance name within the predetermined period exceeds a mean value of all the performance values of the selected I/O performance name.

5. The management computer according to claim 2, wherein the processor is configured to:
select, from the service infrastructure performance relationship information, a second apparatus performance name that forms a pair with the selected service performance name and is different from the first apparatus performance name;
select the performance value of the second apparatus performance name from the performance information;
select the threshold of the second apparatus performance name from the setting threshold information;
determine whether or not the performance value of the second apparatus performance name exceeds the threshold of the second apparatus performance name within the predetermined period; and
evaluate the threshold of the first apparatus performance name based on the determination result of the performance value of the first apparatus performance name, the determination result of the performance value of the service performance name, the determination result of the performance value of the I/O performance name, and a determination result of the performance value of the second apparatus performance name.

6. The management computer according to claim 5, wherein:
the storage unit is configured to hold threshold evaluation information storing the evaluation result of the threshold of the apparatus performance name; and
the processor is configured to:
acquire the evaluation result of the threshold of the second apparatus performance name from the threshold evaluation information; and
evaluate the threshold of the first apparatus performance name based on the determination result of the performance value of the first apparatus performance name, the determination result of the performance value of the service performance name, the determination result of the performance value of the I/O performance name, the determination result of the performance value of the second apparatus performance name, and the evaluation result of the threshold of the second apparatus performance name.

7. The management computer according to claim 6, wherein:
the storage unit is configured to hold exceptional information including a definition of the apparatus performance name that is exceptional in the evaluation of the threshold of the apparatus performance name; and
the processor is configured to:
refer to the exceptional information to determine whether or not the second apparatus performance name is exceptional; and
evaluate the threshold of the first apparatus performance name based on the determination result of the performance value of the first apparatus performance name, the determination result of the performance value of the service performance name, the determination result of the performance value of the I/O performance name, the determination result of the performance value of the second apparatus performance name, the evaluation result of the threshold of the second apparatus performance name, and a determination result indicating whether or not the second apparatus performance name is exceptional.

8. The management computer according to claim 7, wherein:
the apparatus included in the system is a storage apparatus; and
the exceptional information defines that a utilization of a processor of the storage apparatus and a usage rate of a cache memory of the storage apparatus exhibit no correlation in change thereof and are both handled as exceptions in the evaluation.

9. The management computer according to claim 1, wherein the processor is configured to calculate a recommendation range for a new threshold of the first apparatus performance name based on the performance value of the first apparatus performance name at a time at which the determination result of the performance value of the first apparatus performance name is different from the determination result of the performance value of the service performance name.

10. The management computer according to claim 1, wherein:
the setting threshold information is configured to store the threshold set in a past and a time at which the threshold was set; and
the processor is configured to:
select, from the setting threshold information, the threshold of the first apparatus performance name having a time of use falling within a predetermined period;
statistically process the selected threshold; and
evaluate the threshold of the first apparatus performance name based on a result of the statistical processing.

11. The management computer according to claim 1, wherein:
the storage unit is configured to hold:
threshold evaluation information including the evaluation result of the threshold of the apparatus performance name; and
a rule indicating a relationship between a conditional event and an event to be a cause of an occurrence of the conditional event; and
the processor is configured to:
refer to the rule to select the apparatus performance name to be one or more cause candidates relating to the event that has occurred;
acquire the evaluation result of the threshold of the apparatus performance name relating to the conditional event of the rule from the threshold evaluation information; and
determine a likelihood of each of the one more cause candidates based on a number of times that an alert has occurred, which is indicated by the conditional event of the rule, and the evaluation result acquired from the threshold evaluation information.

12. The management computer according to claim 1, wherein:
the storage unit is configured to hold:
threshold evaluation information storing the evaluation result of the threshold of the apparatus performance name; and
a rule indicating a relationship between a conditional event and an event to be a cause of an occurrence of the conditional event; and
the processor is configured to:
refer to the rule to select the apparatus performance name to be one or more cause candidates relating to the event that has occurred;
determine a likelihood of each of the one or more cause candidates based on a number of conditional events of the rule and a number of times that an alert has occurred, which is indicated by the conditional event of the rule;
output the one or more cause candidates and the likelihood of each of the one or more cause candidates;
receive an instruction as to whether or not to conduct a reanalysis of the one or more cause candidates;
change, in the case of receiving the instruction to conduct the reanalysis, the threshold of the apparatus performance name managed by the management computer;
acquire the evaluation result of the threshold of the apparatus performance name managed by the management computer from the threshold evaluation information;
calculate the evaluation result of the changed threshold;
compare the calculated evaluation result with the evaluation result acquired from the threshold evaluation information;
acquire, in the case where the calculated evaluation result is larger than the evaluation result acquired from the threshold evaluation information, the performance value of the apparatus performance name managed by the management computer within an occurrence period of the alert from the performance information;
determine whether or not the performance value acquired from the performance information exceeds the threshold based on the changed threshold;
generate a new alert in the case where the performance value acquired from the performance information exceeds the threshold; and
determine the likelihood of each of the one or more cause candidates based on the generated new alert and the rule.

13. The management computer according to claim 1, wherein:
the storage unit is configured to hold:
threshold evaluation information storing the evaluation result of the threshold of the apparatus performance name; and
a rule indicating a relationship between a conditional event and an event to be a cause of an occurrence of the conditional event; and
the processor is configured to:
refer to the rule to select the apparatus performance name to be one or more cause candidates relating to the event that has occurred;
determine a likelihood of each of the one or more cause candidates based on a number of conditional events of the rule and a number of times that an alert has occurred, which is indicated by the conditional event of the rule;
output the one or more cause candidates and the likelihood of each of the one or more cause candidates;
receive an instruction as to whether or not to conduct a reanalysis of the one or more cause candidates;
change, in the case of receiving the instruction to conduct the reanalysis, the threshold of the apparatus performance name managed by the management computer;
acquire the evaluation result of the threshold of the apparatus performance name managed by the management computer from the threshold evaluation information;
calculate the evaluation result of the changed threshold;
compare the calculated evaluation result, the evaluation result acquired from the threshold evaluation information, and the received evaluation result;
acquire, in the case where the calculated evaluation result is closer to the received evaluation result than the evaluation result acquired from the threshold evaluation information, the performance value of the apparatus performance name managed by the management computer within an occurrence period of the alert from the performance information;
determine whether or not the performance value acquired from the performance information exceeds the changed threshold;
generate a new alert in the case where the performance value acquired from the performance information exceeds the changed threshold; and
determine the likelihood of each of the one or more cause candidates based on the generated new alert and the rule.

14. The management computer according to claim 1, wherein the processor is configured to:
select, from the service infrastructure performance relationship information, the service performance name that forms a pair with the received first apparatus performance name and that measures performance of a different service by the same method as a method of the service performance name;
select the threshold of the selected service performance name from the setting threshold information;
determine whether or not the threshold of the service performance name is such a strict threshold as to be determined to be abnormal in the case of being larger than another threshold; and
evaluate the threshold of the first apparatus performance name through use of a different determination method in the case where the threshold of the service performance name is not the strictest threshold.

15. A method of evaluating a performance threshold for monitoring a system formed of an apparatus through use of a management computer,
the management computer including a storage unit, a processor configured to refer to the storage unit, and an interface for communications to/from the apparatus,
the storage unit being configured to hold:
performance information including a performance value of the apparatus and a performance value of a service provided by the system;
setting threshold information including a threshold which is used for determining whether or not each of the performance values is abnormal; and
service infrastructure performance relationship information including a pair of a service performance name and an apparatus performance name that exhibit correlation in change of performance,
the method comprising steps of:
selecting, by the management computer, in the case where receiving a first apparatus performance name for identifying the performance of the apparatus, the service performance name that forms a pair with the received first apparatus performance name from the service infrastructure performance relationship information;
selecting, by the management computer, the performance value of the received first apparatus performance name and the performance value of the selected service performance name from the performance information;
selecting, by the management computer, the threshold of the received first apparatus performance name and the threshold of the selected service performance name from the setting threshold information;
determining, by the management computer, whether or not the performance value of the first apparatus performance name exceeds the threshold of the first apparatus performance name within a predetermined period;
determining, by the management computer, whether or not the performance value of the service performance name exceeds the threshold of the service performance name within the predetermined period; and
evaluating, by the management computer, the threshold of the first apparatus performance name so as to increase evaluation of the threshold when a determination result of the performance value of the first apparatus performance name and a determination result of the performance value of the service performance name are the same result simultaneously.
